(19) United States
(12) Patent Application Publication
(10) Pub. No.: US 2016/0148097 A1
(43) Pub. Date: May 26, 2016

(54) SYSTEMS AND METHODS FOR KNOWLEDGE MANAGEMENT

(71) Applicant: IFTHISTHEN, INC., New York, NY (US)

(72) Inventor: Michael Angelo GENOVA, III, New York, NY (US)

(21) Appl. No.: 14/903,362

(22) PCT Filed: Jul. 10, 2014
(86) PCT No.: PCT/US2014/046208

§ 371 Date: Jan. 7, 2016

Related U.S. Application Data
(60) Provisional application No. 61/844,768, filed on Jul. 10, 2013.

(51) Int. Cl. G06N 5/02; G06F 3/0484

(52) U.S. Cl. CPC G06N 5/025; G06F 3/0484

(57) ABSTRACT

Methods and systems are provided for managing knowledge. Users of a knowledge management (KM) service or system may post questions, provide answers or search for answers via a user interface. For a given question, users may collectively construct and refine an answer hierarchy that may include multiple answer paths or solutions to the same question. To this end, users may add, remove and/or modify nodes of the answer hierarchy. The nodes may be of predefined types such as Step, Fork, and Goto. In addition, users may interact with a particular node and provide or modify content specific to individual nodes of the answer hierarchy such as attachments, questions, comments, or references. Given an answer hierarchy, users may select different answer paths or solutions comprising a subset of nodes in the answer hierarchy, for example, based on user-specific fact patterns or requirements.

### CROSS-REFERENCE

This application claims the benefit of U.S. Provisional Application No. 61/844,768, filed Jul. 10, 2013, which application is incorporated herein by reference in its entirety.

### BACKGROUND OF THE INVENTION

Knowledge management (KM) systems facilitate the creation, capture, sharing, and transfer of knowledge within an organization or community. Such knowledge often embodies valuable ideas, experiences, insights and best practices from members of such an organization or community. Traditional KM systems are typically configured to allow users with administrative power to store knowledge objects such as documents in databases or repositories. Regular users of the systems can then search such knowledge objects using a search engine. However, such systems often provide poor interaction between the users of the systems. Further, updating the knowledge objects in such KM systems can be a time consuming process for the administrators as more data accumulates in the systems. Social computing platforms such as online forums allow users to post questions and/or provide answers to questions. However, the answers in such platforms are usually provided in an unstructured or ad hoc fashion, making it hard to distill meaningful knowledge that may be re-used by many users. Therefore, there is a need for a knowledge management system that taps into the collective wisdom of users while providing meaningful and structured answers.

### SUMMARY OF THE INVENTION

Methods and systems are provided for managing knowledge. According to an aspect of the present invention, a computer-implemented method for managing knowledge is provided. The method is under the control of one or more computer systems configured with executable instructions and comprises: receiving, via a user interface, a question from a first user; and providing, via the user interface, an answer hierarchy corresponding to the question, the answer hierarchy generated at least in part on responses from one or more other users different from the first user and comprising a plurality of nodes each associated with a predefined node type.

In some embodiments, the answer hierarchy represents an aggregate answer to the question.

In some embodiments, each node in the answer hierarchy represents a step in a solution to the question.

In some embodiments, the predefined node type is selected from a group comprising a Step, Fork, or Goto node type.

In some embodiments, the plurality of nodes includes at least a Fork node with two or more branches.

In some embodiments, the Fork node represents a decision point among two or more solutions corresponding to the two or more branches.

In some embodiments, at least one of the plurality of nodes is associated with node-specific information.

In some embodiments, the node-specific information includes at least one of a comment, a question, a reference, or an attachment.

In some embodiments, providing the answer hierarchy includes allowing the one or more users to add, remove, or edit at least one node of the plurality of nodes.

In some embodiments, editing the at least one node includes adding, removing, or editing node-specific information associated with the at least one node.

In some embodiments, the answer hierarchy provides at least two distinct solutions to the question.

In some embodiments, the method further comprises allowing the first user to select, via the user interface, a user-specific solution from the at least two distinct solutions based at least in part on information specific to the first user.

In some embodiments, selecting the user-specific solution includes selecting, via the user interface, a subset of the plurality of nodes of the answer hierarchy.

In some embodiments, the user-specific solution is displayed via the user interface.

In some embodiments, the method further comprises displaying a first selected node of the plurality of nodes while providing a preview of a second unselected node of the plurality of nodes.

In some embodiments, the user-specific solution is stored, shared, or printed.

In some embodiments, the first user and the one or more other users different from the first user are members of the same organization or group.

In some embodiments, at least one of the one or more computer systems is configured to prevent unauthorized access.

In some embodiments, preventing unauthorized access comprises authenticating users of the one or more computer systems prior to providing access to the at least one of the one or more computer systems.

In some embodiments, authenticating the users of the one or more computer systems includes checking user-provided credentials.

In some embodiments, authenticating the users of the one or more computer systems is performed without user intervention.

In some embodiments, at least one of the one or more computer systems is configured to be non-public.

In some embodiments, the method further comprises providing different levels of access rights with respect to the answer hierarchy to users of the one or more computer systems.

In some embodiments, providing different levels of access rights with respect to the answer hierarchy includes providing only read access to a first subset of the users and providing both read and write access to a second subset of the users.

According to another aspect of the present invention, a knowledge management system is provided. The system comprises: one or more processors; and memory, including instructions executable by the one or more processors to cause the knowledge management system to at least: provide a user interface that enables a plurality of users to collectively edit an answer hierarchy that incorporates responses of the plurality of users to a user-provided question, the answer hierarchy comprising a plurality of nodes each associated with a predefined node type; receive, via the user interface, a user-selection of a subset of the plurality of nodes; and provide a solution to the user-provided question based at least in part on the user-selected subset of the plurality of nodes.

In some embodiments, the answer hierarchy represents an aggregate answer to the question.

In some embodiments, each node in the answer hierarchy represents a step in a solution to the question.

In some embodiments, the predefined node type is selected from a group comprising a Step, Fork, or Goto node type.

In some embodiments, the plurality of nodes includes at least a Fork node with two or more branches.

In some embodiments, the Fork node represents a decision point among two or more solutions corresponding to the two or more branches.

In some embodiments, at least one of the plurality of nodes is associated with node-specific information.

In some embodiments, the node-specific information includes at least one of a comment, a question, a reference, or an attachment.

In some embodiments, providing the answer hierarchy includes allowing the one or more users to add, remove, or edit at least one node of the plurality of nodes.

In some embodiments, editing the at least one node includes adding, removing, or editing node-specific information associated with the at least one node.

In some embodiments, the answer hierarchy provides at least two distinct solutions to the question.

In some embodiments, the instructions executable by the one or more processors further cause the knowledge management system to allow the first user to select, via the user interface, a user-specific solution from the at least two distinct solutions based at least in part on information specific to the first user.

In some embodiments, selecting the user-specific solution includes selecting, via the user interface, a subset of the plurality of nodes of the answer hierarchy.

In some embodiments, the user-specific solution is displayed via the user interface.

In some embodiments, the instructions executable by the one or more processors further cause the knowledge management system to display a first selected node of the plurality of nodes while providing a preview of a second unselected node of the plurality of nodes.

In some embodiments, the user-specific solution is stored, shared, or printed.

In some embodiments, the first user and the one or more other users different from the first user are members of the same organization or group.

In some embodiments, the instructions executable by the one or more processors further cause the knowledge management system to prevent unauthorized access.

In some embodiments, preventing unauthorized access comprises authenticating users of the knowledge management system prior to providing access to the knowledge management system.

In some embodiments, authenticating the users of the knowledge management system includes checking user-provided credentials.

In some embodiments, authenticating the users of the knowledge management system is performed without user intervention.

In some embodiments, the knowledge management system is configured to be non-public.

In some embodiments, the instructions executable by the one or more processors further cause the knowledge management system to provide different levels of access rights with respect to the answer hierarchy to users of the knowledge management system.

In some embodiments, providing different levels of access rights with respect to the answer hierarchy includes providing only read access to a first subset of the users and providing both read and write access to a second subset of the users.

In some embodiments, the first user is a member of the first subset of the users and at least one of the one or more users different from the first users is a member of the second subset of the users.

In some embodiments, the first user is a member of the first subset of the users and at least one of the one or more users different from the first users is a member of the second subset of the users.

According to another aspect of the present invention, one or more non-transitory computer-readable storage media having collectively stored thereon executable instructions that, when executed by one or more processors of a knowledge management system, cause the system to at least: display, via a user interface, an answer hierarchy that incorporates one or more solutions to a user-provided question, the answer hierarchy comprising a plurality of nodes each associated with a predefined node type, each of the one or more solutions corresponding to a subset of the plurality of nodes; and allow one or more users to perform, via the user interface, one or more predefined operations associated with the answer hierarchy, the one or more predefined operations comprising at least adding, removing, or editing at least one node of the plurality of nodes.

In some embodiments, the answer hierarchy represents an aggregate answer to the question.

In some embodiments, each node in the answer hierarchy represents a step in a solution to the question.

In some embodiments, the predefined node type is selected from a group comprising a Step, Fork, or Goto node type.

In some embodiments, the plurality of nodes includes at least a Fork node with two or more branches.

In some embodiments, the Fork node represents a decision point among two or more solutions corresponding to the two or more branches.

In some embodiments, at least one of the plurality of nodes is associated with node-specific information.

In some embodiments, the node-specific information includes at least one of a comment, a question, a reference, or an attachment.

In some embodiments, providing the answer hierarchy includes allowing the one or more users to add, remove, or edit at least one node of the plurality of nodes.

In some embodiments, editing the at least one node includes adding, removing, or editing node-specific information associated with the at least one node.

In some embodiments, the answer hierarchy provides at least two distinct solutions to the question.

In some embodiments, the instructions executable by the one or more processors further cause the knowledge management system to allow the first user to select, via the user interface, a user-specific solution from the at least two distinct solutions based at least in part on information specific to the first user.

In some embodiments, selecting the user-specific solution includes selecting, via the user interface, a subset of the plurality of nodes of the answer hierarchy.

In some embodiments, the user-specific solution is displayed via the user interface.

In some embodiments, the instructions executable by the one or more processors further cause the knowledge management system to display a first selected node of the plurality of nodes while providing a preview of a second unselected node of the plurality of nodes.

In some embodiments, the user-specific solution is stored, shared, or printed.

In some embodiments, the first user and the one or more other users different from the first user are members of the same organization or group.

In some embodiments, the instructions executable by the one or more processors further cause the knowledge management system to prevent unauthorized access.

In some embodiments, preventing unauthorized access comprises authenticating users of the knowledge management system prior to providing access to the knowledge management system.

In some embodiments, authenticating the users of the knowledge management system includes checking user-provided credentials.

In some embodiments, authenticating the users of the knowledge management system is performed without user intervention.

In some embodiments, the knowledge management system is configured to be non-public.

In some embodiments, the instructions executable by the one or more processors further cause the knowledge management system to provide different levels of access rights with respect to the answer hierarchy to users of the knowledge management system.

In some embodiments, providing different levels of access rights with respect to the answer hierarchy includes providing only read access to a first subset of the users and providing both read and write access to a second subset of the users.

In some embodiments, the first user is a member of the first subset of the users and at least one of the one or more users different from the first users is a member of the second subset of the users.

According to another aspect of the present invention, a computer-implemented method for managing knowledge is provided. The method is under the control of one or more computer systems configured with executable instructions and comprises: providing a user interface that enables a plurality of users to collectively edit an answer hierarchy that incorporates responses of the plurality of users to a user-provided question, the answer hierarchy comprising a plurality of nodes each associated with a predefined node type; receiving, via the user interface, a user-selection of a subset of the plurality of nodes; and providing a solution to the user-provided question based at least in part on the user-selected subset of the plurality of nodes.

In some embodiments, the answer hierarchy represents an aggregate answer to the question.

In some embodiments, each node in the answer hierarchy represents a step in a solution to the question.

In some embodiments, the predefined node type is selected from a group comprising a Step, Fork, or Goto node type.

In some embodiments, the plurality of nodes includes at least a Fork node with two or more branches.

In some embodiments, the Fork node represents a decision point among two or more solutions corresponding to the two or more branches.

In some embodiments, at least one of the plurality of nodes is associated with node-specific information.

In some embodiments, the node-specific information includes at least one of a comment, a question, a reference, or an attachment.

In some embodiments, editing the answer hierarchy includes adding, remove, or editing at least one node of the plurality of nodes.

In some embodiments, editing the at least one node includes adding, removing, or editing node-specific information associated with the at least one node.

In some embodiments, providing the solution to the question comprising displaying, via the user interface, the user-selected subset of the plurality of nodes.

In some embodiments, providing the solution to the question further comprises storing, sharing, or printing the solution.

In some embodiments, the method further comprises displaying a first selected node of the plurality of nodes while providing a preview of a second unselected node of the plurality of nodes.

In some embodiments, the method further comprises preventing unauthorized access.

In some embodiments, preventing unauthorized access comprises authenticating the plurality of users prior to providing access.

In some embodiments, authenticating the plurality of users includes checking user-provided credentials.

In some embodiments, authenticating the plurality of users is performed without user intervention.

In some embodiments, the method further comprises providing different levels of access rights with respect to the answer hierarchy to users.

In some embodiments, providing different levels of access rights with respect to the answer hierarchy includes providing only read access to a first of the users and providing both read and write access to a second subset of the users.

According to another aspect of the present invention, a knowledge management system is provided. The system comprises: one or more processors; and memory, including instructions executable by the one or more processors to cause the knowledge management system to at least: provide a user interface that enables a plurality of users to collectively edit an answer hierarchy that incorporates responses of the plurality of users to a user-provided question, the answer hierarchy comprising a plurality of nodes each associated with a predefined node type; receive, via the user interface, a user-selection of a subset of the plurality of nodes; and provide a solution to the user-provided question based at least in part on the user-selected subset of the plurality of nodes.

In some embodiments, the answer hierarchy represents an aggregate answer to the question.

In some embodiments, each node in the answer hierarchy represents a step in a solution to the question.

In some embodiments, the predefined node type is selected from a group comprising a Step, Fork, or Goto node type.

In some embodiments, the plurality of nodes includes at least a Fork node with two or more branches.

In some embodiments, the Fork node represents a decision point among two or more solutions corresponding to the two or more branches.

In some embodiments, at least one of the plurality of nodes is associated with node-specific information.

In some embodiments, the node-specific information includes at least one of a comment, a question, a reference, or an attachment.

In some embodiments, editing the answer hierarchy includes adding, remove, or editing at least one node of the plurality of nodes.

In some embodiments, editing the at least one node includes adding, removing, or editing node-specific information associated with the at least one node.

In some embodiments, providing the solution to the question comprising displaying, via the user interface, the user-selected subset of the plurality of nodes.

In some embodiments, providing the solution to the question further comprises storing, sharing, or printing the solution.

In some embodiments, the instructions executable by the one or more processors further cause the knowledge management system to display a first selected node of the plurality of nodes while providing a preview of a second unselected node of the plurality of nodes.

In some embodiments, the instructions executable by the one or more processors further cause the knowledge management system to prevent unauthorized access.

In some embodiments, preventing unauthorized access comprises authenticating the plurality of users prior to providing access.

In some embodiments, authenticating the plurality of users includes checking user-provided credentials.

In some embodiments, authenticating the plurality of users is performed without user intervention.

In some embodiments, the instructions executable by the one or more processors further cause the knowledge management system to provide different levels of access rights with respect to the answer hierarchy to users of the knowledge management system.

In some embodiments, providing different levels of access rights with respect to the answer hierarchy includes providing only read access to a first of the users and providing both read and write access to a second subset of the users.

According to another aspect of the present invention, one or more non-transitory computer-readable storage media having collectively stored thereon executable instructions that, when executed by one or more processors of a knowledge management system, cause the system to at least: provide a user interface that enables a plurality of users to collectively edit an answer hierarchy that incorporates responses of the plurality of users to a user-provided question, the answer hierarchy comprising a plurality of nodes each associated with a predefined node type; receive, via the user interface, a user-selection of a subset of the plurality of nodes; and provide a solution to the user-provided question based at least in part on the user-selected subset of the plurality of nodes.

In some embodiments, the answer hierarchy represents an aggregate answer to the question.

In some embodiments, each node in the answer hierarchy represents a step in a solution to the question.

In some embodiments, the predefined node type is selected from a group comprising a Step, Fork, or Goto node type.

In some embodiments, the plurality of nodes includes at least a Fork node with two or more branches.

In some embodiments, the Fork node represents a decision point among two or more solutions corresponding to the two or more branches.

In some embodiments, at least one of the plurality of nodes is associated with node-specific information.

In some embodiments, the node-specific information includes at least one of a comment, a question, a reference, or an attachment.

In some embodiments, editing the answer hierarchy includes adding, remove, or editing at least one node of the plurality of nodes.

In some embodiments, editing the at least one node includes adding, removing, or editing node-specific information associated with the at least one node.

In some embodiments, providing the solution to the question comprising displaying, via the user interface, the user-selected subset of the plurality of nodes.

In some embodiments, providing the solution to the question further comprises storing, sharing, or printing the solution.

In some embodiments, the instructions executable by the one or more processors further cause the knowledge management system to display a first selected node of the plurality of nodes while providing a preview of a second unselected node of the plurality of nodes.

In some embodiments, the instructions executable by the one or more processors further cause the knowledge management system to prevent unauthorized access.

In some embodiments, preventing unauthorized access comprises authenticating the plurality of users prior to providing access.

In some embodiments, authenticating the plurality of users includes checking user-provided credentials.

In some embodiments, authenticating the plurality of users is performed without user intervention.

In some embodiments, the instructions executable by the one or more processors further cause the knowledge management system to provide different levels of access rights with respect to the answer hierarchy to users of the knowledge management system.

In some embodiments, providing different levels of access rights with respect to the answer hierarchy includes providing only read access to a first of the users and providing both read and write access to a second subset of the users.

According to an aspect of the present invention, a computer-implemented method for managing knowledge is provided. The method is under the control of one or more computer systems configured with executable instructions and comprises: displaying, via a user interface, an answer hierarchy that incorporates one or more solutions to a user-provided question, the answer hierarchy comprising a plurality of nodes each associated with a predefined node type, each of the one or more solutions corresponding to a subset of the plurality of nodes; and allowing one or more users to perform, via the user interface, one or more predefined operations associated with the answer hierarchy, the one or more predefined operations comprising at least adding, removing, or editing at least one node of the plurality of nodes.

In some embodiments, the answer hierarchy represents an aggregate answer to the question.

In some embodiments, each node in the answer hierarchy represents a step in a solution to the question.

In some embodiments, the predefined node type is selected from a group comprising a Step, Fork, or Goto node type.

In some embodiments, the plurality of nodes includes at least a Fork node with two or more branches.

In some embodiments, the Fork node represents a decision point among two or more solutions corresponding to the two or more branches.

In some embodiments, at least one of the plurality of nodes is associated with node-specific information.

In some embodiments, the node-specific information includes at least one of a comment, a question, a reference, or an attachment.

In some embodiments, editing the at least one node comprises adding, removing, or editing node-specific information associated with the at least one node.

In some embodiments, the method further comprises receiving, via the user interface, a user-selection of a subset of the plurality of nodes; and providing one of the one or more solutions to the user-provided question based at least in part on the user-selected subset of the plurality of nodes.

In some embodiments, providing one of the one or more solutions comprises displaying the solution via the user interface.

In some embodiments, providing one of the one or more solutions further comprises storing, sharing, or printing the solution.

In some embodiments, the method further comprising displaying a first selected node of the plurality of nodes while providing a preview of a second unselected node of the plurality of nodes.

In some embodiments, at least one of the one or more computer systems is configured to prevent unauthorized access.

In some embodiments, preventing unauthorized access comprises authenticating users of the one or more computer systems prior to providing access to the at least one of the one or more computer systems.

In some embodiments, authenticating the users of the one or more computer systems includes checking user-provided credentials.

In some embodiments, authenticating the users of the one or more computer systems is performed without user intervention.

In some embodiments, at least one of the one or more computer systems is configured to be non-public.

In some embodiments, the method further comprises providing different levels of access rights with respect to the answer hierarchy to users of the one or more computer systems.

In some embodiments, providing different levels of access rights with respect to the answer hierarchy includes providing only read access to a first subset of the users and providing both read and write access to a second subset of the users.

According to another aspect of the present invention, a knowledge management system is provided. The system comprises: one or more processors; and memory, including instructions executable by the one or more processors to cause the knowledge management system to at least: display, via a user interface, an answer hierarchy that incorporates one or more solutions to a user-provided question, the answer hierarchy comprising a plurality of nodes each associated with a predefined node type, each of the one or more solutions corresponding to a subset of the plurality of nodes; and allow one or more users to perform, via the user interface, one or more predefined operations associated with the answer hierarchy, the one or more predefined operations comprising at least adding, removing, or editing at least one node of the plurality of nodes.

In some embodiments, the answer hierarchy represents an aggregate answer to the question.

In some embodiments, each node in the answer hierarchy represents a step in a solution to the question.

In some embodiments, the predefined node type is selected from a group comprising a Step, Fork, or Goto node type.

In some embodiments, the plurality of nodes includes at least a Fork node with two or more branches.

In some embodiments, the Fork node represents a decision point among two or more solutions corresponding to the two or more branches.

In some embodiments, at least one of the plurality of nodes is associated with node-specific information.

In some embodiments, the node-specific information includes at least one of a comment, a question, a reference, or an attachment.

In some embodiments, editing the at least one node comprises adding, removing, or editing node-specific information associated with the at least one node.

In some embodiments, the instructions executable by the one or more processors further cause the knowledge management system to: receive, via the user interface, a user-selection of a subset of the plurality of nodes; and provide one of the one or more solutions to the user-provided question based at least in part on the user-selected subset of the plurality of nodes.

In some embodiments, providing one of the one or more solutions comprises displaying the solution via the user interface.

In some embodiments, providing one of the one or more solutions further comprises storing, sharing, or printing the solution.

In some embodiments, the instructions executable by the one or more processors further cause the knowledge management system to display a first selected node of the plurality of nodes while providing a preview of a second unselected node of the plurality of nodes.

In some embodiments, the knowledge management system is configured to prevent unauthorized access.

In some embodiments, preventing unauthorized access comprises authenticating users of the knowledge management system prior to providing access to the at least one of the knowledge management system.

In some embodiments, authenticating the users of the knowledge management system includes checking user-provided credentials.

In some embodiments, authenticating the users of the knowledge management system is performed without user intervention.

In some embodiments, the knowledge management system is configured to be non-public.

In some embodiments, the instructions executable by the one or more processors further cause the knowledge management system to provide different levels of access rights with respect to the answer hierarchy to users of the knowledge management system.

In some embodiments, providing different levels of access rights with respect to the answer hierarchy includes providing only read access to a first subset of the users and providing both read and write access to a second subset of the users.

According to another aspect of the present invention, one or more non-transitory computer-readable storage media having collectively stored thereon executable instructions that, when executed by one or more processors of a knowledge management system, cause the system to at least: display, via a user interface, an answer hierarchy that incorporates one or more solutions to a user-provided question, the answer hierarchy comprising a plurality of nodes each associated with a predefined node type, each of the one or more solutions corresponding to a subset of the plurality of nodes; and allow one or more users to perform, via the user interface, one or more predefined operations associated with the answer hierarchy, the one or more predefined operations comprising at least adding, removing, or editing at least one node of the plurality of nodes.

In some embodiments, the answer hierarchy represents an aggregate answer to the question.

In some embodiments, each node in the answer hierarchy represents a step in a solution to the question.

In some embodiments, the predefined node type is selected from a group comprising a Step, Fork, or Goto node type.

In some embodiments, the plurality of nodes includes at least a Fork node with two or more branches.

In some embodiments, the Fork node represents a decision point among two or more solutions corresponding to the two or more branches.

In some embodiments, at least one of the plurality of nodes is associated with node-specific information.

In some embodiments, the node-specific information includes at least one of a comment, a question, a reference, or an attachment.

In some embodiments, editing the at least one node comprises adding, removing, or editing node-specific information associated with the at least one node.

In some embodiments, the instructions executable by the one or more processors further cause the knowledge management system to: receive, via the user interface, a user-selection of a subset of the plurality of nodes; and provide one of the one or more solutions to the user-provided question based at least in part on the user-selected subset of the plurality of nodes.

In some embodiments, providing one of the one or more solutions comprises displaying the solution via the user interface.

In some embodiments, providing one of the one or more solutions further comprises storing, sharing, or printing the solution.

In some embodiments, the instructions executable by the one or more processors further cause the knowledge management system to display a first selected node of the plurality of nodes while providing a preview of a second unselected node of the plurality of nodes.

In some embodiments, the knowledge management system is configured to prevent unauthorized access.

In some embodiments, preventing unauthorized access comprises authenticating users of the knowledge management system prior to providing access to the at least one of the knowledge management system.

In some embodiments, authenticating the users of the knowledge management system includes checking user-provided credentials.

In some embodiments, authenticating the users of the knowledge management system is performed without user intervention.

In some embodiments, the knowledge management system is configured to be non-public.

In some embodiments, the instructions executable by the one or more processors further cause the knowledge management system to provide different levels of access rights with respect to the answer hierarchy to users of the knowledge management system.

In some embodiments, providing different levels of access rights with respect to the answer hierarchy includes providing only read access to a first subset of the users and providing both read and write access to a second subset of the users.

Additional aspects and advantages of the present disclosure will become readily apparent to those skilled in this art from the following detailed description, wherein only exemplary embodiments of the present disclosure are shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates an exemplary environment for implementing a knowledge management (KM) service, in accordance with some embodiments.

FIG. 2 illustrates exemplary components of a computer device for implementing aspects of the present invention, in accordance with some embodiments.

FIG. 3 illustrates exemplary interactions between a KM service and users of such a service, in accordance with some embodiments.

FIG. 4 illustrates exemplary interactions between a KM service and users of such a service, in accordance with some embodiments.

FIGS. 5a-c illustrate exemplary node types in an answer hierarchy, in accordance with some embodiments.

FIG. 6 illustrates exemplary target nodes that a Goto node may point to, in accordance with some embodiments.

FIG. 7 illustrates an exemplary answer hierarchy, in accordance with some embodiments.

FIG. 8 illustrates another exemplary answer hierarchy, in accordance with some embodiments.

FIG. 9 illustrates an exemplary answer hierarchy with node-specific information, in accordance with some embodiments.

FIG. 10 illustrates an exemplary answer hierarchy comprising multiple answer paths or solutions, in according to some embodiments.

FIG. 11 illustrates an exemplary process for implementing a KM service, in accordance with some embodiments.

FIG. 12 illustrates an exemplary process for adding a node to an answer hierarchy, in accordance with some embodiments.

FIG. 13 illustrates an exemplary process for removing a node from an answer hierarchy, in accordance with some embodiments.

FIG. 14 illustrates an exemplary process for modifying node-specific information, in accordance with some embodiments.

FIG. 15 illustrates an exemplary process for searching for an answer, in accordance with some embodiments.

FIG. 16 illustrates an exemplary user interface (UI) of a KM system, in accordance with some embodiments.

FIGS. 17a-b illustrate exemplary UIs representing forks in an answer hierarchy, in accordance with some embodiments.

FIG. 18 illustrates exemplary UIs for some types of nodes in an answer hierarchy, in accordance with some embodiments.

FIG. 19 illustrates an exemplary UI for creating one or more Step nodes, in accordance with some embodiments.

FIG. 20 illustrates an exemplary UI for creating Fork and Branch nodes, in accordance with some embodiments.

FIG. 21 illustrates an exemplary UI for creating a Goto node, in accordance with some embodiments.

FIG. 22 illustrates an exemplary UI showing a selected element in an answer hierarchy, in accordance with some embodiments.

FIG. 23 illustrates an exemplary UI showing a node with associated node-specific information, some embodiments.

FIG. 24 illustrates a portion of an exemplary an answer hierarchy, in accordance with some embodiments.

FIG. 25 illustrates exemplary UIs for displaying various types of node-specific information, in accordance with some embodiments.

FIG. 26 illustrates exemplary UIs for creating comments and questions for a given node, in accordance with some embodiments.

FIG. 27 illustrates exemplary UIs for creating references and attachments for a given node, in accordance with some embodiments.

### DETAILED DESCRIPTION OF THE INVENTION

Methods, systems, and apparatus are provided for managing knowledge. Users of a knowledge management (KM) service or system may post questions, provide answers or search for answers via a user interface. For a given question, users may collectively construct and refine an answer hierarchy that may include multiple answer paths or solutions to the same question. To this end, users may add, remove and/or modify nodes of the answer hierarchy. The nodes may be of predefined types such as Step, Fork, and Goto. In addition, users may interact with a particular node and provide or modify content specific to individual nodes of the answer hierarchy such as attachments, questions, comments, or references. Given an answer hierarchy, users may select different answer paths or solutions comprising a subset of nodes in the answer hierarchy, for example, based on user-specific fact patterns or requirements. The users may preview and compare alternative answer paths to help them make their selections.

According to an aspect of the present invention, methods and systems are provided for providing “wisdom management” in addition to the traditional notion of knowledge management. Traditional knowledge management systems have been used primarily to store and accumulate past and/or known knowledge. Examples can include a traditional knowledge management system within a law firm that is used to accumulate legal forms and rules. However, such traditional knowledge management systems typically do not actively suggest solutions for solving future unforeseeable problems. Wisdom management, on the other hand, involves organizing and distilling past knowledge in a way that facilitate future decision making. The present invention provides wisdom management in addition to traditional knowledge management by organizing answers as decision trees or hierarchies and presenting them in an interactive user interface. Users facing a future problem can navigate such answer hierarchies based on a future scenario to find a solution that is applicable to that particular future scenario.

Unlike traditional knowledge manage systems that are merely used to store and accumulate past known information and knowledge (e.g., knowledge within a particular organization), the present invention allows “wisdom management”

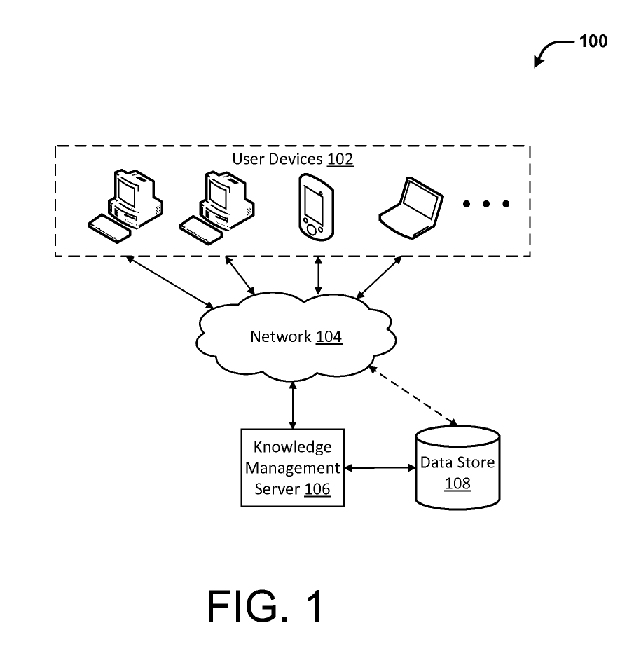

FIG. 1 illustrates an exemplary environment 100 for implementing a KM service, in accordance with some embodiments. In this example, one or more user devices 102 connect via a network 104 to a knowledge management (KM) server 106.

In various embodiments, the user devices 102 may include any devices capable of communicating with the KM server 106, such as personal computers, smartphones, tablet computing devices, and the like. The user devices 102 may include applications such as web browsers capable of communicating with the KM server 106, for example, via an interface provided by the KM server 106. Such an interface may include an application programming interface (API) such as a web service interface, a graphical user interface (GUI), and the like.

The KM server 106 may be implemented by one or more physical and/or logical computing devices or computer systems that collectively provide the functionalities of a KM service described herein. In an embodiment, the KM server 106 communicates with a data store 108 to retrieve and/or store data used for the KM service. The data store 108 may include one or more databases (e.g., SQL database), data storage devices (e.g., tape, hard disk, solid-state drive), data storage servers, data storage services (such as cloud-based data storage services), or the like. In various embodiments, such a data store 108 may be connected to KM server 106 locally or remotely via a network.

In some embodiments, KM server 106 may comprise one or more computing services provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like. In some embodiments, data store 108 may comprise one or more storage services provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

In various embodiments, network 104 may include the Internet, a local area network (“LAN”), a wide area network (“WAN”), a cellular data network, wireless network or any other public or private data network.

In some embodiments, the KM service described herein may comprise a client-side component residing in a user device 102 and a server-side component residing in a KM server 106. The client-side component may be configured to implement the frontend logic of the KM service such as receiving, validating, or otherwise processing an input (such as a question) from a user, sending a request (e.g., an HTTP request) to the server module, receiving and/or processing a response (e.g., an HTTP response) from the server component, and presenting the response to the user (e.g., in a web browser). In some embodiments, the client component may be implemented using Asynchronous JavaScript and XML (AJAX), JavaScript, Adobe Flash, Microsoft Silverlight or any other suitable client-side web development technologies. In some embodiments, the client-side component includes software applications downloadable to mobile devices (“apps”) that are configured to implement the knowledge management methods described herein.

In an embodiment, the server component may be configured to implement the backend logic of the KM service such as storing data related to questions, answers (including answer hierarchy data structures, nodes, relationship between the nodes, and information associated with the nodes), users, and the like. The backend logic can also include retrieving and updating such data. In various embodiments, the server component may be implemented by one or more physical or logical computer systems using ASP, .Net, Java, Python, or any suitable server-side web development technologies. In some embodiments, the client component and server component may communicate using any suitable web service protocol such as Simple Object Access Protocol (SOAP).

In some embodiments, the KM system or service described herein may be configured to provide security mechanisms to prevent unauthorized access or intrusions. For instance, users may be required to login or otherwise be authenticated in order to use some or all functionalities of the system. Any suitable authentication methods may be used such as multipart authentication. Such authentication methods may require a user to provide information based on a variety of authentication factors such as something that the user knows (e.g., username, identifier, password, pass phrase, personal identification number (PIN), and challenge response such as CAPTCHA response), something that the user has (e.g., security token, ID card, hardware token such as built-in with mobile devices and software token), and something the user is or does (e.g., signature, facial features, voice, fingerprint, retinal pattern, DNA, or other biometric identifier). For example, a user may be required to enter credentials (e.g., username and/or password), which are checked against a database of user credentials before being allowed or denied access. In some embodiments, such authentication may be performed automatically without user intervention such as via auto-identifiers, cookies, and the like.

In some embodiments, the KM system or service described herein may be configured to be privately accessible only to a particular group of users such as members within an organization or group. Some or all of the features of the system may be accessible only to the group of user, and not to the general public. The features of the system including the user interface and data may be customized for the particular group of users and/or organization. In other embodiments, the KM system and service described herein may be available to the general public.

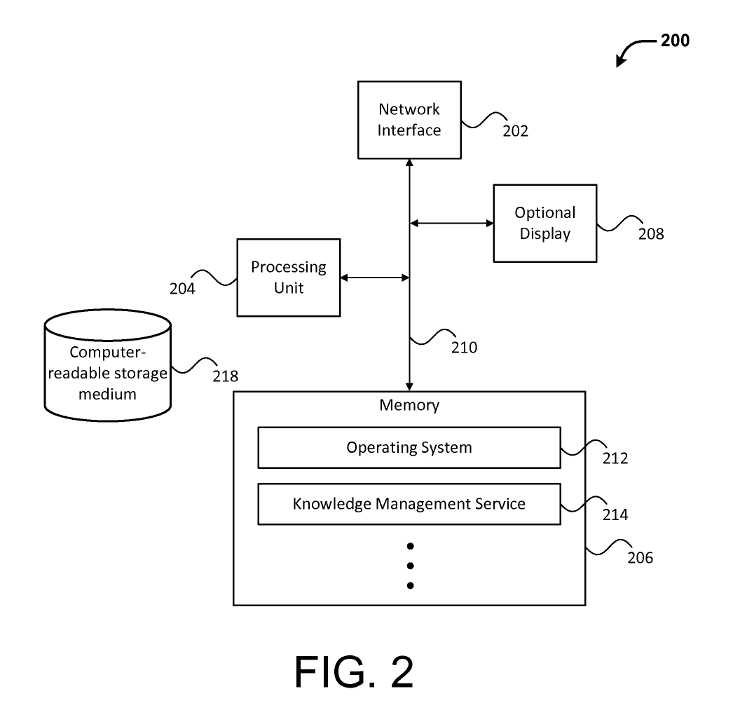

FIG. 2 illustrates exemplary components of a computer device 200 for implementing aspects of the present invention, in accordance with some embodiments. In an embodiment, the computer device 200 may include or may be included in a device or system such as the KM server 106 illustrated in FIG. 1. In some embodiments, computing device 200 may include many more components than those shown in FIG. 2. However, it is not necessary that all of these generally conventional components be shown in order to disclose an illustrative embodiment.

As shown in FIG. 2, computing device 200 includes a network interface 202 for connecting to a network such as discussed above. In various embodiments, the computing device 200 may include one or more network interfaces 202 for communicating with one or more types of networks such as IEEE 802.11-based networks, cellular networks and the like.

In an embodiment, computing device 200 also includes one or more processing units 204, a memory 206, and an optional display 208, all interconnected along with the network interface 202 via a bus 210. The processing unit(s) 204 may be capable of executing one or more methods or routines stored in the memory 206. The optional display 208 may be configured to provide a graphical user interface to a user operating the computing device 200 for receiving user input, displaying output, and/or executing applications.

The memory 206 may generally comprise a random access memory (“RAM”), a read only memory (“ROM”), and/or a permanent mass storage device, such as a disk drive. The memory 206 may store program code for an operating system 212, one or more KM service routines 214, and other routines. In some embodiments, the KM service routines 214 may be executed to provide the knowledge management functionalities as described herein.

In some embodiments, the software components discussed above may be loaded into memory 206 using a drive mechanism associated with a non-transient computer readable storage medium 218, such as a floppy disc, tape, DVD/CD-ROM drive, memory card, USB flash drive, solid state drive (SSD) or the like. In other embodiments, the software components may alternatively be loaded via the network interface 202, rather than via a non-transient computer readable storage medium 218.

In some embodiments, the computing device 200 also communicates via bus 210 with one or more local or remote databases or data stores such as an online data storage system via the bus 210 or the network interface 202. The bus 210 may comprise a storage area network (“SAN”), a high-speed serial bus, and/or via other suitable communication technology. In some embodiments, such databases or data stores may be integrated as part of the computing device 200.

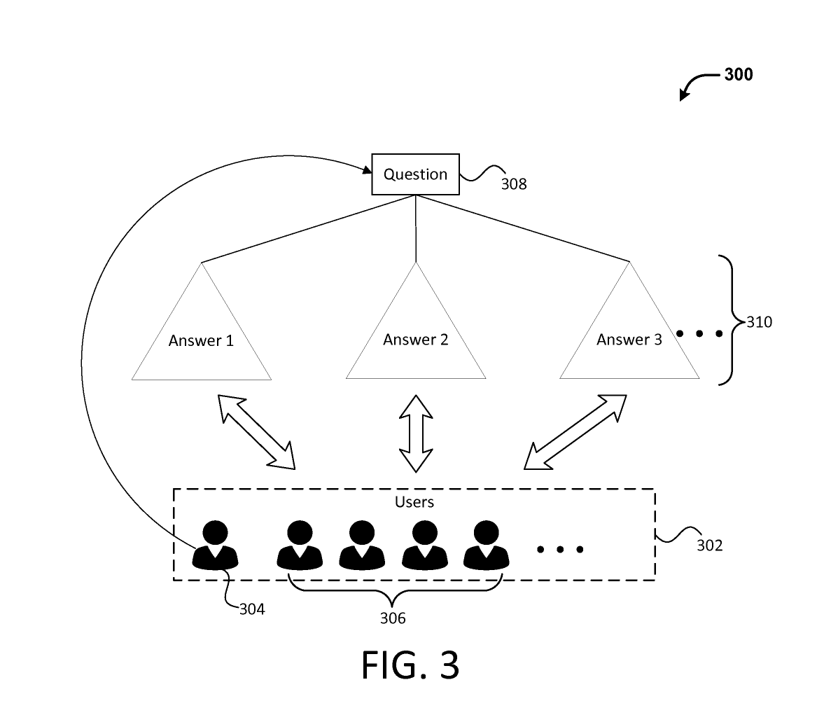

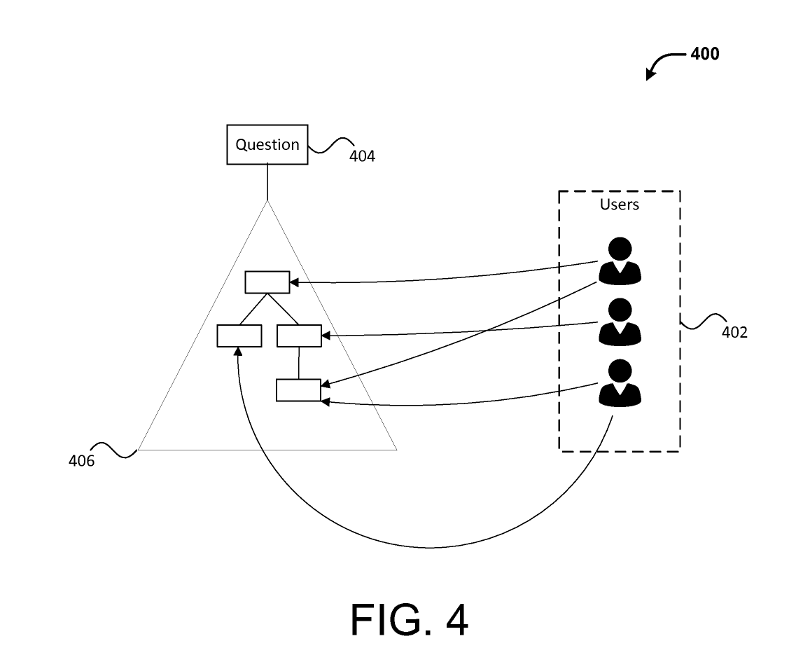

FIG. 3 illustrates exemplary interactions between a KM service 300 and users of such a service, in accordance with some embodiments. As shown, users 302 of the service 300 may collectively contribute to questions 308 and/or corresponding answers 310 using the KM service 300. For example, a user 304 may pose a question 308 using the service 300. In response to this question 308, one or more answers 310 may be provided based on responses from other users 306 of the service 300. The other users 306 may include users that are different from the user 304 that posts the question. The other users 306 may or may not include users that are members of the same organization or group as the user 304 that posts the question. In various embodiments, one user may contribute to multiple answers and multiple users may contribute to one answer. The latter scenario is discussed in further detail in connection with FIG. 4. In some embodiments, the originator 304 of the question may also contribute to the answers to his/her own question, for example, by adding further questions, comments, or other information related to the answer 310 or to the question 308.

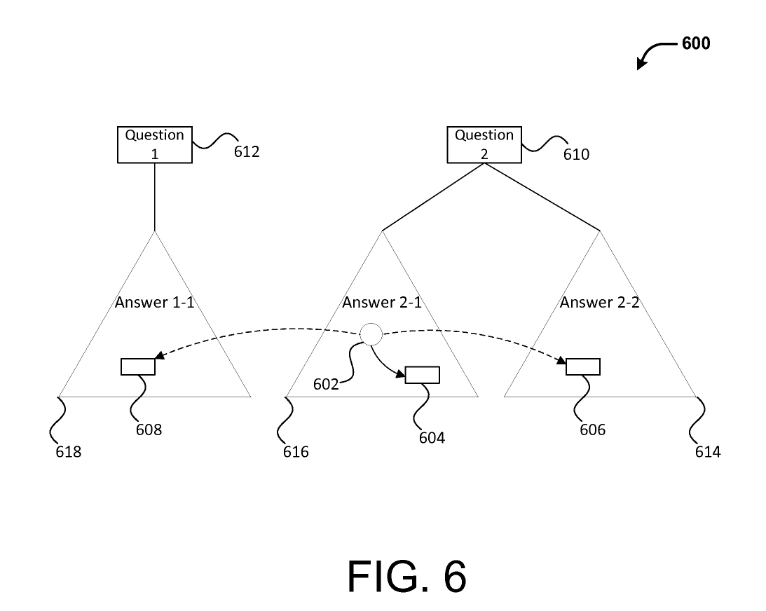

FIG. 4 illustrates exemplary interactions between a KM service and users of such a service, in accordance with some embodiments. As illustrated, multiple users 402 may contribute to an answer 406 for a question 404, for example, by expanding, revising and updating the answer 406 in real time or substantially real time. In an embodiment, an answer 406 to a question 404 may be represented in a data structure such as a hierarchy (an “answer hierarchy”) comprising one or more nodes and edges (directed or undirected) connecting the nodes (such as illustrated by FIG. 6). While the term answer hierarchy is used herein, it is understood that any suitable graph, model, or data structure may be used instead to represent the aggregate answer to the question.

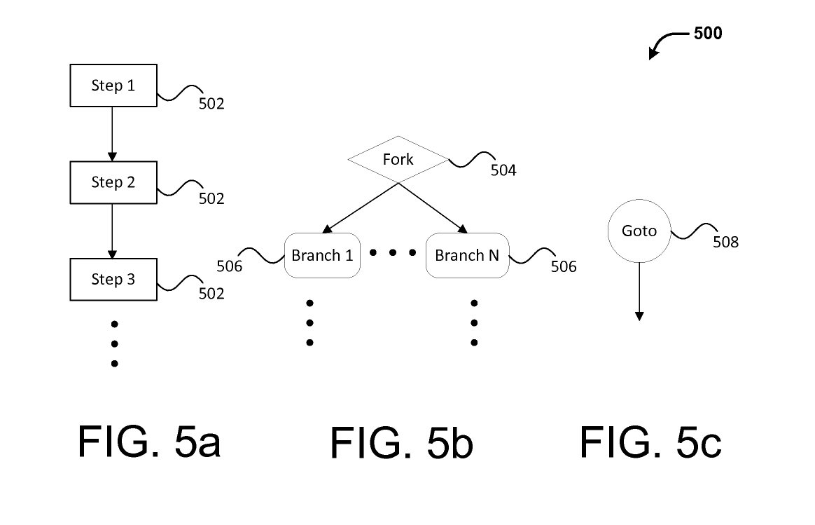

The root node of the hierarchy may represent the starting point for an answer to a question. Each node may represent a Step, Fork, Goto (jump) (such as illustrated by FIG. 5) or an otherwise predefined node type. An answer hierarchy can provide a guideline or roadmap to finding a solution to a particular problem. Starting from the root node of the answer hierarchy, a user can navigate through a series of nodes (an answer path) within the answer hierarchy using the connecting edges. Each node in the answer path provides a portion of the solution. For example, a Step node can represent a step in a procedure required to solve the problem. A Fork node can represents a decision point to select from a plurality of possible courses of actions to take depending on the specific fact pattern. As such, in some embodiments, an answer hierarchy is configured to provide multiple different solutions (e.g., answer paths) to the same problem based on different scenarios or fact patterns.

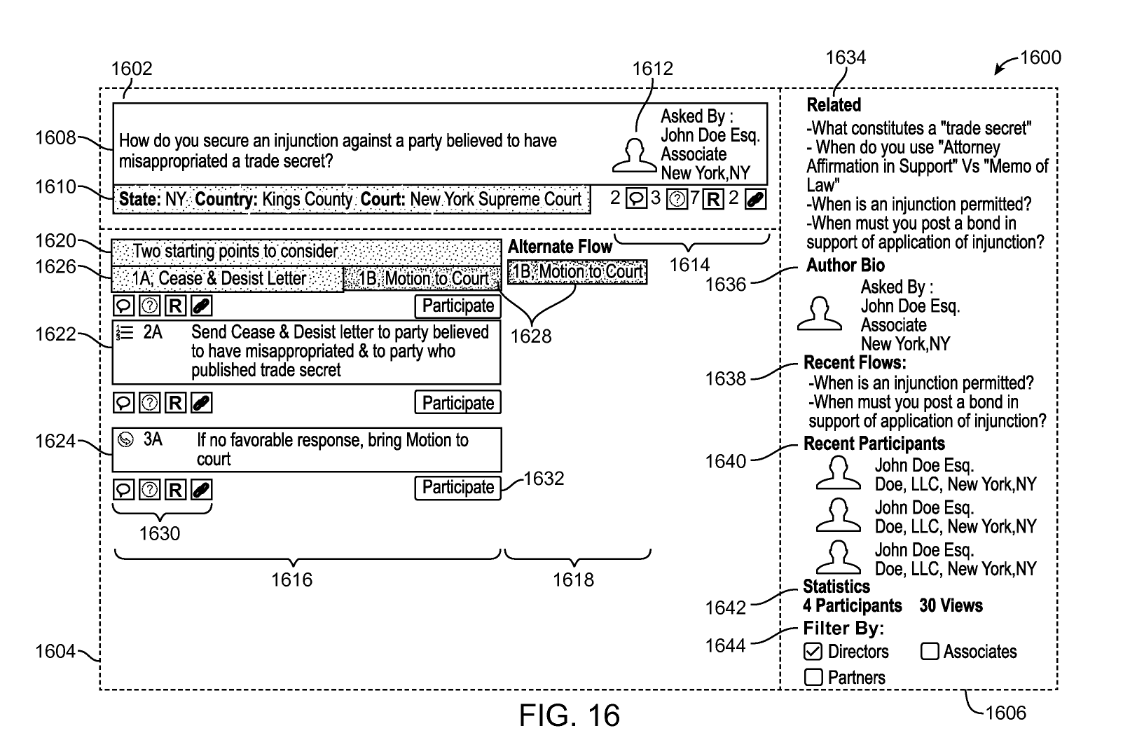

In various embodiments, users may view and interact with a visual representation of an answer hierarchy using a user interface of the KM system such as described in FIGS. 16-27.

A user may contribute to an answer by adding, removing, or otherwise modifying one or more nodes of the answer hierarchy. For example, a user may add a node representing an extra step, or a branch node representing a new option in the answer hierarchy. The user may also remove one or more nodes from the answer hierarchy.

The user may also modify information related to one or more nodes in the answer hierarchy. In some embodiments, users may associate additional useful information with some or all of the nodes in an answer hierarchy. Such additional information may include comments, questions, attachments (e.g., documents, pictures, audio/video clips), references (e.g., a Uniform Resource Locator (URL) link), and the like. Such additional useful information may be associated with one node or multiple nodes in an answer hierarchy. Furthermore, the users may also modify such node-specific information by adding, removing, or editing some of such information. For example, a user may add or remove an attachment, edit a comment, or update a link associated with a node.

In some embodiments, access control rules or business policies may be used to control who can read or write to an answer hierarchy or a portion thereof. Such access control rules may be associated with entities at different levels of granularities such as a question or answer hierarchy, a group of questions or answer hierarchies, a node of an answer hierarchy, a piece of node-specific information such as a link, and the like. For instance, in some embodiments, every user has the right to read information but only a subset of users have the right to write (e.g., add, remove, and/or edit) information.

As another example, a first set of users (e.g., users with managerial authority such as partners or senior associates in a law firm) may be allowed to add or remove nodes, thereby modifying the overall structure of answer hierarchies; whereas a second set of users (e.g., junior associates in a law firm) may only be allowed to edit information related to existing nodes such as adding and/or removing node-specific information (e.g., comments and attachments). Thus, a partner or department head may have the ability to provide a skeleton or outline of an answer hierarchy, for example, by adding the nodes in the hierarchy. The partner may also have the ability to add additional information to the nodes but may choose not to do so for efficiency purposes. Instead, he or she may ask other users such as more junior members of the team to provide additional details for some or all of the existing nodes. Such a tiered access control scheme facilitates an answer-generation process for providing answers where users with more experience and/or responsibility can provide a high-level control of the general structure of an answer while users with less experience and/or responsibility are allowed to provide low-level details to specific portions of the answer.

In some other embodiments, users' access rights to an answer hierarchy may be segmented according to the content of the data contained in the answer hierarchy. For example, a user that specializes in a particular practice area may have full access rights to a particular portion of the answer hierarchy (e.g., a sub-hierarchy) that pertains to that practice area. The same user may have limited access rights to other portions of the same answer hierarchy.

In some embodiments, such access control rules may be defined by system administrator(s) and/or user(s) based on user information (e.g., user identity, user role, privileges, position, access rights and/or credentials), information about the accessed entity (e.g., confidentiality, created-by information), and/or other factors. For instance, users may have different levels of access rights based on the user's identity or position and/or job role within an organization.

In some embodiments, different users may be tasked with creating different portions of an answer hierarchy. For example, a user with editing

The KM service or system described herein allows users to collaboratively create and update, in real time, an answer hierarchy by contributing to various portions of the answer hierarchy. As such, the resulting answer is likely to accurately reflect the latest development in an industry or sector that the answer pertains to because it is based on the collective wisdom of all the contributors to the answer. On the other hand, the KM service provides guidance and structure to the creation and updating of answers to ensure that the answers are meaningful, re-usable, and easy-to-use by users. For example, rules and policies may be enforced to ensure the validity, access control, and consistency of the hierarchy. As an example, a node may only belong to a predefined type. As another example, some nodes may not be visible or editable by certain users.

With answer hierarchies, the present invention provides a one-stop shop for both answer providers and answer seekers. For answer providers, each answer hierarchy functions as a central reservoir where answers to a specific question are added, refined and updated. Thus, each answer hierarchy is likely to grow organically over time to reflect the most up-to-date collective wisdom. For answer seekers, each answer hierarchy can provide a one-stop shop for multiple solutions for a question, each may be suitable or desirable under a particular set of conditions. Thus, the answer seekers can pick and choose the solutions that best suit their particular needs based on the same answer hierarchy. For both answer providers and seekers, significant cost savings can be achieved with respect to the time and effort required to manage knowledge (e.g., providing, updating, and/or searching for answers).

FIG. 5a-c illustrate exemplary node types in an answer hierarchy, in accordance with some embodiments. FIG. 5a illustrates exemplary “Step” nodes 502. A Step node may represent a step in an answer that outlines the steps to take to solve a problem. For example, a simplified answer in response to a question of “how to get a driver's license?” may include three steps of “pass a written test,” “pass a road test” and “pay licensing fees.”

FIG. 5b illustrates exemplary “Fork” node 504 and “Branch” nodes 506. A Fork node 504 may be associated with two or more Branch nodes 506. The Fork node 504 may represent a decision point where a user needs to decide which of the two or more Branch nodes 506 to take. Such decision may be based, for example, on the particular fact patter or situation of the user. To aid user decision, a Fork node 504 may be associated with one or more questions or criteria and which Branch nodes 506 to take may depend on the answer(s) to the question(s) or the results of the evaluation of the criteria. For example, a Fork node may require a user to evaluate a question of “passed the written test?” A “Yes” to the question may lead to a Branch node of “take road test” and a “No” to the question may lead to a Branch node of “retake the written test.”

FIG. 5c illustrates an exemplary “Goto” node 508. A Goto node directs the flow of an answer to a target node. Using the example above, a Goto node may follow the Branch node of “retake the written test” and point to existing Step nodes (if any) for taking the written test.

FIG. 6 illustrates exemplary target nodes that a Goto node may point to, in accordance with some embodiments. In various embodiments, a Goto node may point to any existing node or nodes in any suitable answer hierarchy. For example, in some cases, a Goto node 602 in an answer hierarchy 616 may point to another node 604 in the same answer hierarchy 616. In some other cases, the Goto node 602 may point to a node 606 in a different answer hierarchy 614 to the same question 610. In yet some other cases, the Goto node 602 may point to a node 608 in an answer hierarchy 618 for a different question 612.

In some embodiments, configurable filters or access control or business rules may be applied to limit the nodes available as target nodes for a given Goto node. Such filters or access control rules may take into account characteristics associated with the questions, answers, users and the like. For example, some questions or answers may be visible only limited audience. As such, the nodes within those answers may be configured as unavailable as target nodes to some users. As another example, some nodes of an answer hierarchy may be unavailable to the user based on the position or job role of the user.

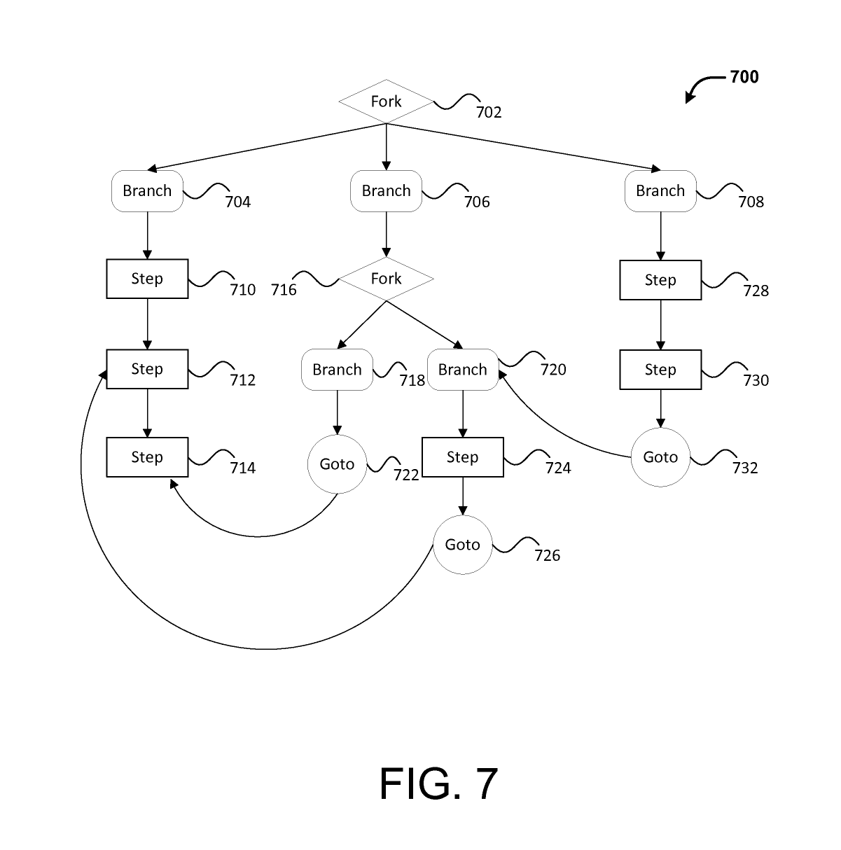

FIG. 7 illustrates an exemplary answer hierarchy 700, in accordance with some embodiments. The root node of the answer hierarchy 700 is a Fork node 702. The Fork node 702 is associated with three Branch nodes 704, 706 and 708. Following the Branch node 704 are three Step nodes 710, 712, and 714 arranged in a linear fashion. Following the Branch node 706 is a second Fork node 716 and two Branch nodes 718 and 720. A Goto node 722 following the Branch node 718 points to the Step node 714. Following the Branch node 720 are a Step node 724 and a Goto node 726 that points to the Step node 712. Following the Branch node 708 are two Step nodes 728 and 730 and a Goto node 732 that points to the Branch node 720. In various embodiments, a Goto node may point to another node of any type such as a Step node, Branch node, Fork node, or even another Goto node. In some other embodiments, a Goto node may only point to a restricted set of nodes. Such restrictions may be enforced based on rules and policies that may be configured (e.g., by a system administrator or a user).

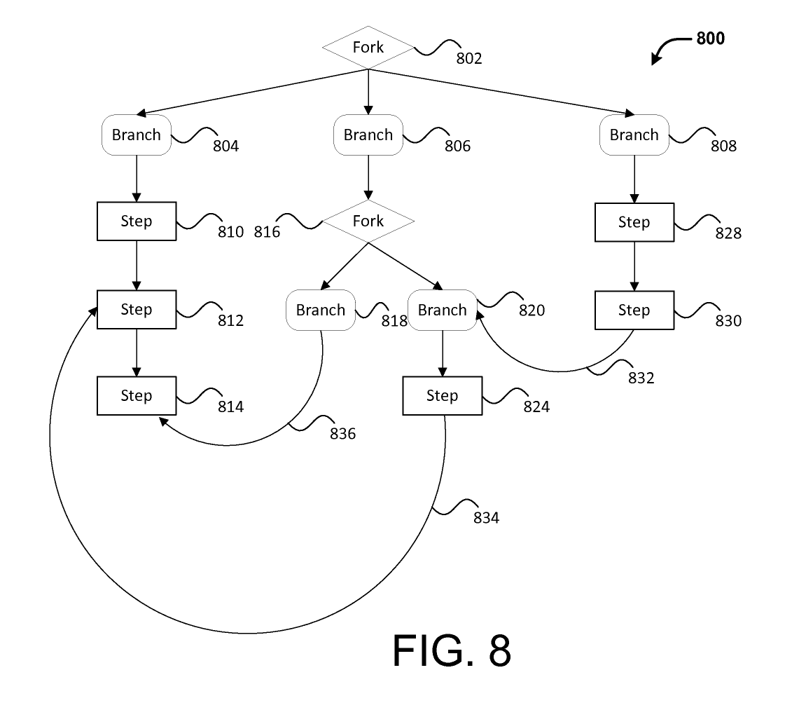

FIG. 8 illustrates another exemplary answer hierarchy 800, in accordance with some embodiments. The answer hierarchy 800 is similar to the answer hierarchy 700 discussed above in connection with FIG. 7, except in FIG. 8, Goto nodes are not necessary for going from a source node to a target node. Instead, directed edges 832, 834 and 836 directly point from the source nodes to the target nodes. In various embodiments, more, less and/or different types of nodes than discussed herein may be used to represent an answer hierarchy.

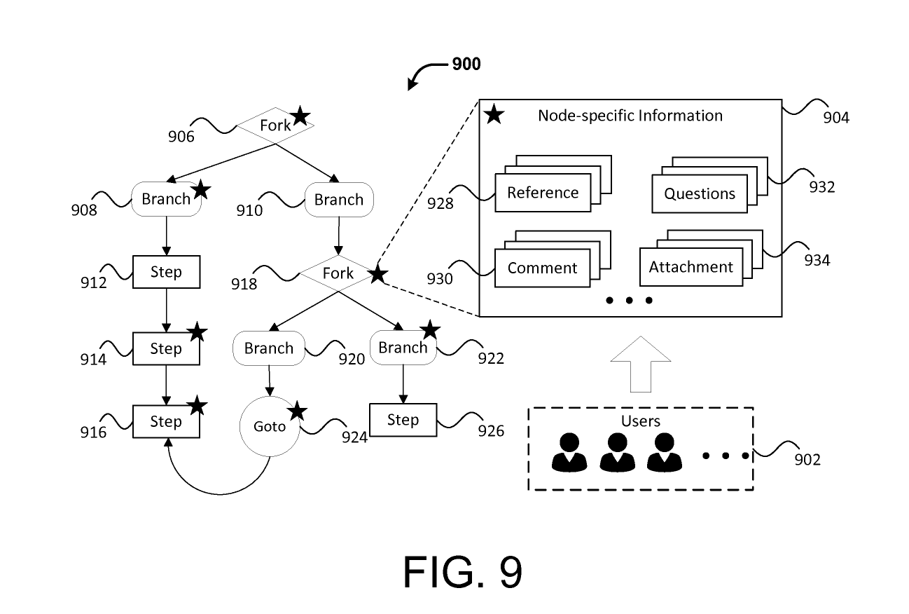

As discussed, users of the KM system discussed herein may refine the content of an answer hierarchy by providing and/or editing information associated with individual nodes in the answer hierarchy. FIG. 9 illustrates another exemplary answer hierarchy 900 with node-specific information, in accordance with some embodiments.

In various embodiments, some or all nodes of an answer hierarchy may each be associated with additional information that pertains to the particular node. For example, as illustrated in FIG. 9, nodes 906, 908, 914, 916, 918, 922 and 924 are each associated with respective node-specific information 904 that pertains to the associated node, whereas the other nodes 910, 912, 920 and 926 do not have corresponding node-specific information.

Additionally or alternatively, information may be associated with or applicable to a subset of the nodes of an answer hierarchy that includes more than one node or with the entire answer hierarchy, as opposed to individual nodes.

In various embodiments, node-specific information generally allows users to interact with nodes in an answer hierarchy by elaborating or providing more information about a particular node, or by asking questions and receiving answers about that node. The node-specific information may include any information provided by one or more users 902 and/or information provided by the system be default. In some embodiments, node-specific information is limited to a predefined set of types. For example, node-specific information 904 may include references 928, comments 930, questions 932, attachments 934 and the like.

A reference 928 may include a link to a document, a web page, or the like. For example, a node for “getting a driver's license” may have a reference link to a web page of a state department of licensing or to a document containing the current driver's manual. As another example, a node for “filing a motion to court” may include a URL link to local court rules. As yet another example, a node for “baking chocolate chip cookies” may include a link to a YouTube video.

In some embodiments, attachment 934 of actual documents, pictures, multimedia objects (e.g., audio/video clips) may also be uploaded by users for a particular node. For example, an opinion of a legal case may be attached as a document to a legal step node in an answer. As another example, multimedia objects may be provided, for example, to better illustrate how to perform a step or to help people with visual impairment understand the step.

In some embodiments, users may provide comments 930 such as tips or personal experience related to a particular node. Additionally, users may ask questions 932 about a particular node, thereby soliciting further elaboration or comments from other users. In other embodiments, more or less types of objects than illustrated may be provided.

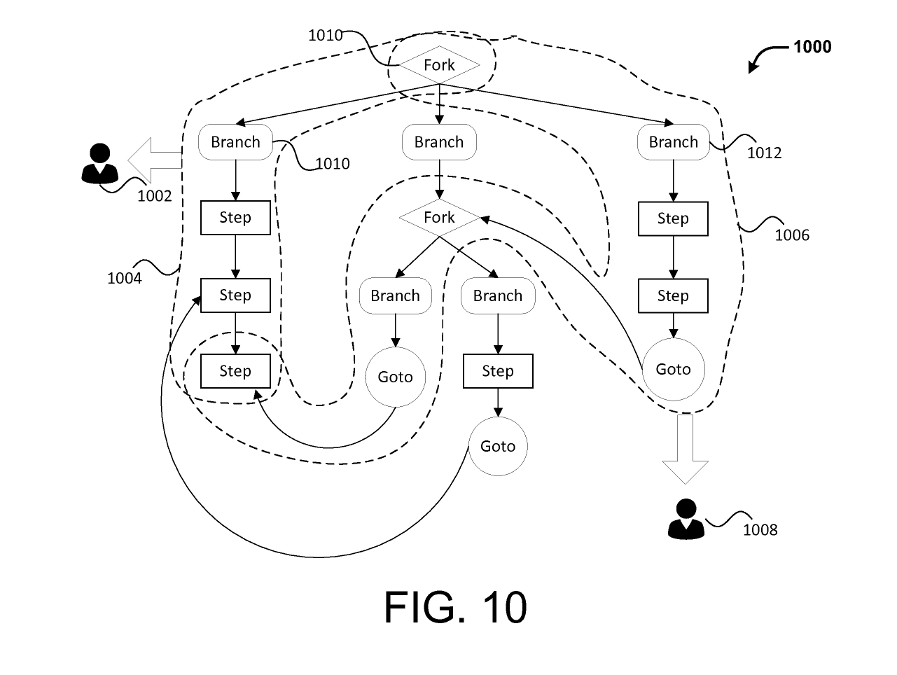

As discussed above, an answer hierarchy can provide alternative answer paths or solutions to a question, for example, by including forks and branches such as described herein. Each of the answer paths may comprise a subset of the nodes of the answer hierarchy that are connected by edges. By choosing different paths from the answer hierarchy, users may find different solutions adapted to their unique situation or fact patterns. FIG. 10 illustrates an exemplary answer hierarchy 1000 including multiple answer paths or solutions, in according to some embodiments. In this example, from the root Fork node 1010, users 1002 and 1008 decide to select different Branch nodes 1010 and 1012, respectively, based on user-specific circumstances or fact patterns. Subsequently, users 1002 and 1008 may each identify the answer paths 1004 and 1006, respectively, by selecting a different subset of the nodes of the answer hierarchy 1000. In general, two answer paths are different if there is at least one node that is in one of the answer paths and not in the other. In some embodiments, an “audit trail” of an answer path may be automatically generated based on a user's navigation within an answer hierarchy. Once identified, one or more answer paths may be saved (e.g., on a local or remote file system or data store), shared (e.g., by email or via a social network), printed, or otherwise processed or used by a user. In some cases, such as illustrated in FIG. 10, multiple users may identify different answer paths within the same answer hierarchy. In some other cases, the same user may identify different answer paths (e.g., at different points in time) for various situations.

Advantageously, such an answer hierarchy as discussed herein provides a centralized place where users may collectively create and refine alternative answer paths to the same problem, reducing wasted efforts of multiple users creating the same or similar answers (or “reinventing the wheels”). Additionally, as many people work on a single answer hierarchy rather than fewer people working on many similar answers, the answer hierarchy is more likely to be comprehensive, accurate and up-to-date. On the other hand, by incorporating various answer paths or solutions, an answer hierarchy provides a one-stop shop for answer seekers to find the answers or solutions that suits their particular needs.

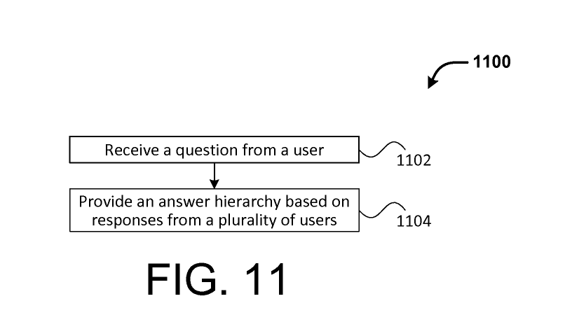

FIG. 11 illustrates an exemplary process 1100 for implementing a KM service, in accordance with some embodiments. Aspects of the process 1100 may be performed, for example, by the KM server 106 discussed in connection with FIG. 1 or computing device 200 discussed in connection with FIG. 2. Some or all of the process 1100 (or any other processes described herein, or variations and/or combinations thereof) may be performed under the control of one or more computer/control systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory. The order in which the operations are described is not intended to be construed as a limitation, and any number of the described operations may be combined in any order and/or in parallel to implement the processes.

In an embodiment, process 1100 includes receiving 1102 a question from a user. In various embodiments, a user interface (UI) may be provided to allow users to interact with the KM system and/or each other. Such a UI may be configured to enable users to perform one or more operations discussed herein such as asking questions, searching for answers, providing answers and other answer-related information and the like.

To ask a question, a user may enter a question (or keywords or phrases thereof) into an input control in the UI such as a text field or box. In an embodiment, based on the user input, similar queries may be automatically suggested, for example, based on the relevancy of the queries, search history of the user and/or other factors. The user may or may not select a query from the auto-suggested queries. Based on the user-entered question, one or more existing answers may be provided 1104. Such answers may be associated with questions that are similar to the user-entered question (e.g., with respect to keywords or subject matter). The user may browse through to find the best one. If there are no existing answers for the user-entered question or if the user is unsatisfied with any existing answers, the user may decide to post the user-entered question as a new question.

In an embodiment, an answer hierarchy is provided 1104 based on responses from a plurality of users. The users may collectively contribute to the answer hierarchy via the UI discussed above. For example, the users may expand the answer hierarchy over time by adding nodes (e.g., Fork, Step, or Goto), or removing nodes from within the answer hierarchy. As another example, the users may add, remove or edit node-specific information such as attachments, links, comments and questions. FIGS. 16-27 provide exemplary UIs for supporting such operations as discussed herein.

In some embodiments, access control rules or business policies may be used to control who can read or write to an answer hierarchy or a portion thereof. Such access control rules may be associated with entities at different levels of granularities such as a question or answer hierarchy, a group of questions or answer hierarchies, a node of an answer hierarchy, a piece of node-specific information such as a link, and the like. For instance, in some embodiments, every user has the right to read information but only a subset of users have the right to write (e.g., add, remove, and/or edit) information. Such access control rules may be defined by system administrator(s) and/or user(s) based on user information (e.g., user identity, user role, privileges, position, access rights and/or credentials), information about the accessed entity (e.g., confidentiality, created-by information), and/or other factors. For instance, users may have different levels of access rights based on the user's identity or position and/or job role within an organization.

In various embodiments, an answer hierarchy may be completed by

In some embodiments, the resulting answer hierarchy may include a series of linear steps where some or all of the steps have associated step-specific information. In some other embodiments, the resulting answer hierarchy may encompass at least a Fork node or similar node, thereby embodying at least two answer paths or solutions such as discussed in connection with FIG. 10. Such answer paths or solutions are distinct even though some of the nodes in the answer paths may overlap.

In some embodiments, the answer hierarchy may be provided 1104 to a user, for example, by displaying it in a browser window running on a user device, with or without other information. In some embodiments, the answer hierarchy may be displayed in a visual representation such as similar to that illustrated in FIGS. 7-10. In other embodiments, the answer hierarchy may be displayed in a substantially textual manner (e.g., as a list or outline). In various embodiments, various push or pull technologies may be used to provide such information to the users.

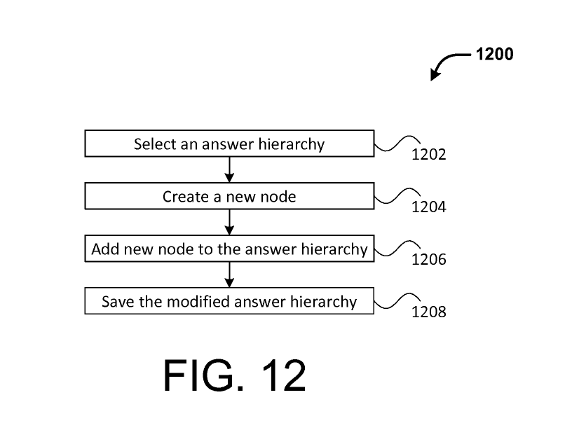

As discussed, users may contribute to an answer hierarchy by adding one or more nodes to the answer hierarchy. FIG. 12 illustrates an exemplary process 1200 for adding a node to an answer hierarchy, in accordance with some embodiments. Process 1200 may be implemented, for example, to enable users to expand an answer hierarchy with new information.

In an embodiment, process 1200 includes selecting 1202 an answer hierarchy. A user may select an answer hierarchy, for example, by searching for answers in a similar manner as discussed in connection with step 1102 of process 1100 of FIG. 1. Where there is no existing answer hierarchy for a question, a user may elect to create an answer hierarchy by starting to add nodes to it.

In some embodiments, a user may create 1204 a new node by selecting from a predefined set of node templates or types. Such a predefined set of node types may include those discussed in connection with FIGS. 5a-c. The node types may be system-defined or user-defined. As part of or after creating the node, a user may fill out information about the node such as a label, title, description, link or the like. In some embodiments, a user may also configure access permissions to the node.

The newly created node may be added 1206 to the answer hierarchy. A user may select the location for the newly added node, for example, by dragging and dropping a new node to a visual representation of the answer hierarchy. Alternatively, a user may select a control (e.g., a “Participate” button) associated with a particular node of the answer hierarchy to add a new node near the selected node. In some embodiments, the orders of the steps 1204 and 1206 may be reversed and/or combined. For example, a user may select a location for a new node before it is created or perform both steps at once.

In some embodiments, the modified answer hierarchy with one or more newly created nodes may be stored, for example, in a data store such as the data store 108 discussed in connection with FIG. 1. The user interface may be updated in real time or substantially real time to reflect the modified answer hierarchy.

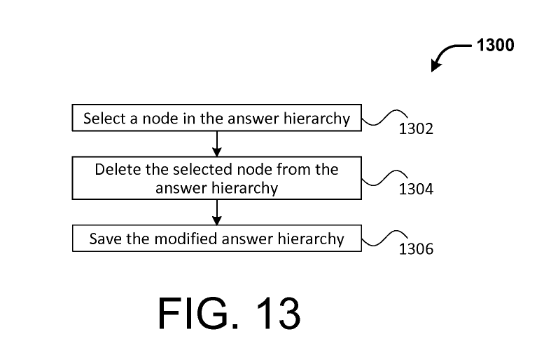

As discussed, in some embodiments, users may contribute to an answer hierarchy by removing one or more nodes from the answer hierarchy. FIG. 13 illustrates an exemplary process 1300 for removing a node from an answer hierarchy, in accordance with some embodiments. Process 1300 may be implemented, for example, to enable users to remove outdated information from an answer hierarchy.

In an embodiment, process 1300 includes selecting 1302 a node from an existing answer hierarchy for deletion. Selecting 1302 a node may require a user to navigate the answer hierarchy from the root node until the desired node is reached. Alternatively, the node may be selected 1302 from a list of all available nodes or a graphical representation of the answer hierarchy.

Once the node is selected, a user may cause the node to be deleted 1304, for example, by selecting a control (e.g., a button or menu item) associated with the node. In some cases, such as in case of a Step or a Goto node, only the selected node is removed. In other embodiments, such as in the case of a Branch node, any children descending from the selected node are also deleted.

In some embodiments, whether a node can be deleted may be dictated by access control or business rules based on user information (e.g., job role, access rights), type of content to be deleted, and the like. For example, certain users with administrative power may be allowed to delete any node while others can only remove a subset of the nodes (e.g., nodes created by them). In some embodiments, deleting a node may require confirmation and/or approval from a different user or users (e.g., administrators and/or node creators). In some embodiments, the removal of the nodes may be permanent. In other embodiments, the removal may be reversible, for example, within a predefined grace period.

The modified answer hierarchy with one or more nodes removed may be stored 1306, for example, in a data store such as the data store 108 discussed in connection with FIG. 1. The user interface may be updated in real time or substantially real time to reflect the modified answer hierarchy.

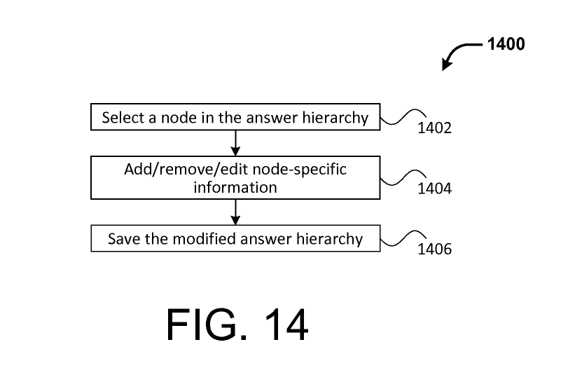

According to an aspect of the present invention, users may contribute to an answer hierarchy by modifying (e.g., add, removing or editing) node-specific information to a node in an answer hierarchy. FIG. 14 illustrates an exemplary process 1400 for modifying node-specific information, in accordance with some embodiments. Process 1400 may be implemented, for example, to allow users to elaborate or refine a portion of the answer hierarchy.

In an embodiment, process 1400 includes selecting 1402 a node from an existing answer hierarchy, such as discussed above in connection with step 1302 of process 1300 of FIG. 13. Subsequently, information specific to the node may be modified, for example, by adding, removing or editing node-specific information such as comments, questions, references, attachments and the like. In some embodiments, such operations may or may not be performed by users using a drag-and-drop interface. In some embodiments, a user may be allowed to associate a piece of information (e.g., a comment or a link) with two or more nodes at a time, and/or dissociate the information from two or more nodes at a time. In some embodiments, access rules may control the extent to which a user may modify node-specific information. For example, such information may appear read-only to some users while editable to others. As an example, a user may be allowed to edit or remove only information provided by the same user. Eventually, modified answer hierarchy may be stored 1406, for example, in a data store such as the data store 108 discussed in connection with FIG. 1.

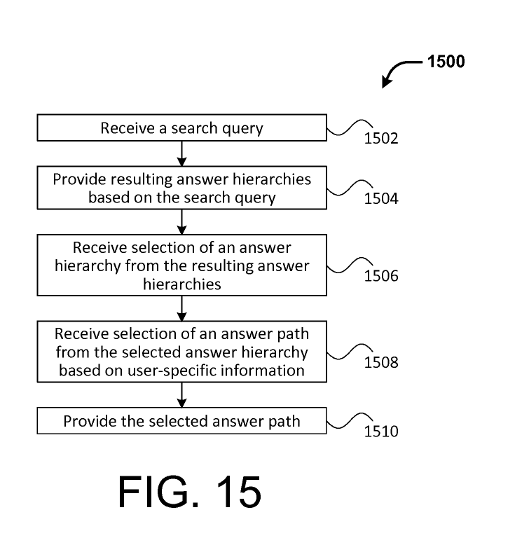

According to another aspect of the present invention, users may search for answers using the KM service or system described herein. FIG. 15 illustrates an exemplary process 1500 for searching for an answer, in accordance with some embodiments. Process 1500 may be implemented, for example, to enable users to search for answer hierarchies based on search queries and identify an answer path within a resulting answer hierarchy.

In an embodiment, process 1500 includes receiving 1502 a search query. Such a search query may be received from a UI discussed in connection with step 1102. The search query may include one or more keywords that a user enters in a search box provided by the UI. Additionally or alternatively, the search query may include one or more search criteria or search filters that the user selects or enters via the UI. Such search criteria or filters may be applied to various attributes of an answer such as subject matter, pertinent geographic area or jurisdiction, time constraints, user information, and the like. In some embodiments, search queries may be provided by users at varying levels of granularities. For example, a user may specify a keyword search to search in keywords associated with answer hierarchies. Additionally, the user may enter one or more search filters that are applicable to individual nodes within a given answer hierarchy. Such may be the case when a user only want to view certain portion of content included in the given answer hierarchy. For example, a user may only want to view certain type of content or content provided by certain users. In some embodiments, previously-entered queries (by the same or different users) may be automatically suggested based on the user-entered queries. In addition to or instead of user-specified search queries, system-generated search queries may be applied in the search for answer hierarchies. Such system-generated search queries may be based, for example, on access control or business rules.

The search queries discussed above may be executed against existing answer hierarchies and one or more resulting answer hierarchies may be provided 1504. In various embodiments, data objects including UI objects corresponding to information related to questions, answer hierarchies, and the like may be stored in any suitable data structures in the data store such as the data store 108 discussed in connection with FIG. 1 or any other suitable system. The search queries may be executed against such data stores to retrieve the appropriate results. In some embodiments, a list of the resulting answer hierarchies that satisfy the user-entered search queries may be displayed to the user in the UI. Furthermore, content within the resulting answer hierarchies may be filtered according to search filters such that some content may be hidden or otherwise render ineligible to the user. In some embodiments, the results may be sorted by default or in a user-specified sort order. Where the search yields no result, the user may be allowed to ask a brand new question such as discussed in connection with step 1102 of process 1100 of FIG. 1. Various push or pull technologies may be used to connect users and answers. For example, instead of a user searching for answer hierarchies, customized answer hierarchies determined to be likely suitable to a user may be pushed to the user's device, for example, based on user-specified criteria, user preferences, and the like.

In an embodiment, a user-selection of an answer hierarchy from the resulting list of answer hierarchies may be received 1506, for example, via the UI. Subsequently, a selection of an answer path within the selected answer hierarchy is received 1508. Such a selection of answer path may be based on a user's navigation of the given answer hierarchy. Navigation and/or selection of the answer path can involve selecting of at least some of the nodes included in the answer path. Navigation of the answer hierarchy (e.g., selection of Branch nodes) may be based on user-specific information such as the unique fact pattern of the user. For example, a user may start from the root node of an answer hierarchy and navigate down the answer hierarchy, selecting branches based on the user's specific fact pattern or needs. Each answer path comprising a series of nodes may represent a unique solution the same problem. Thus, different users, viewing the same answer hierarchy, may find different user-specific solutions within the same answer hierarchy by navigating down different answer paths based on user-specific fact pattern or experience.

In an embodiment, the selected answer path may be stored 1510, for example, in a data store such as the data store 108 discussed in connection with FIG. 1. In an embodiment, the answer path may be saved automatically, for example, as “audit trail” information associated the user. In another embodiment, the answer path may be saved upon express indication from the user. Besides saving the answer path, in some embodiments, a user may also share the answer path (e.g., via email messages, text messages, social networks, etc.), print the answer path, or perform other operations with the answer path.

In some embodiments, individual answer paths can be associated with approval indicators to indicate that the answer paths have been approved by certain users. For example, a particular answer path can be indicated as approved by a person with managerial authority. In some cases, the approved answer path can be used as the preferred solution over other unapproved answer paths. For example, a head of a department or a partner of a practice group may approve a particular answer path to indicate that the solution or procedure represented by the answer path should be used to handle a particular type of situation for that department or group.

The approval indicators can be associated with entire answer paths. Such approval indicators can be referred to as path-level approval indicators. Alternatively or additionally, approval indicators can be associated with individual nodes within an answer path. For instance, approval indicator can be associated with each of the nodes (i.e., node-level approval indicators). Alternatively or additionally, approval indicators can be associated subsets of nodes within an answer path. An approval indicator associated with a subset of nodes can be referred to as a set-level approval indicator. In various embodiments, an answer path, node, or subset of nodes can be approvable by one or more users, at various levels. A user may approve one or more answer paths, nodes, or subsets of nodes.

Approval indicators can be represented in the UI using any suitable representation including checkmarks, star, different color schemes, and the like. The approval indicators may vary to distinguish different users, levels (e.g., path-level, node-level, or set-level), and the like.

Any suitable methods may be provided for approving the answer paths. For example, a data object representing the answer path can be provided to users who need to approve them. Such data objects may include a file (e.g., pdf or word file) containing a visual representation (e.g., screenshot) of the selected answer path. The visual representation the selected answer path may show all the nodes contained in the answer path. The data object may be displayed to users via the user interface such as described herein, emailed to the user, or otherwise provided to the users. A user may indicate approval of the answer path or an element thereof by selecting a suitable UI control, replying to emails, or via any suitable method.

In various embodiments, the approval of the answer paths, nodes and/or sets of nodes may occur at any anytime during the lifetime of an answer hierarchy. For instance, approval may occur during the time or after a particular answer path is generated. Approvals may be obtained and/or required at any suitable frequency. Obtaining approvals at lower frequencies (e.g., only after the completion of an answer path) can help limit the time commitment required from approvers. On the other hand, obtaining approvals at higher frequencies (e.g., when each of the nodes of the answer is generated) may improve the accuracy of the answer paths at the cost of time for the approvers. In some embodiments, any aspect associated with the approval process such as whether approval is required, level of approval required, users to send to approval requests to, timing of when approvals are required, and the like, may be configurable by system administrators, users, or any suitable entities.

FIGS. 16-27 illustrate exemplary UIs implementing the present invention, according to some embodiments. The illustrated UIs are provided for illustrative purposes only. In various embodiments, any suitable UIs may be used to implement similar functionalities as discussed herein. In various embodiments, the users of the KM system described herein may interact with the UI via any suitable input mechanisms such as including touchscreen, stylus, keyboard, mouse, and the like.

FIG. 16 illustrates an exemplary UI 1600 of a KM system, in accordance with some embodiments. Such a UI 1600 may be provided, for example, to display information about a question and an associated answer hierarchy.

In the illustrated embodiment, the UI 1600 is divided into a question section 1602, answer section 1604 and a related-information section 1606. The question section 1602 may maintain a relatively fixed position (e.g., at the top of a page) regardless of scrolling of other sections of the page. The question section 1602 may include the text 1608 of a question and a related-information tab 1612. The related-information tab 1612 may display information about the author of the question (e.g., name, position or title, location, profile picture or avatar, etc.). Selecting (e.g., via a mouse click or touch of a finger) on the related-information tab 1612 may trigger display of more detailed related-information about the question or answer, for example, in the related-information section 1606. The question section 1602 may also include some metadata 1610 (e.g., State, County, Court) that may be used to categorize the question or answer and link related questions or answers. The question section 1602 may also include statistics 1614 of node-specific information such as a count for each type of node-specific information (e.g., comments, questions, references, attachments, etc.) for an answer hierarchy associated with the question.

The answer section 1604 may provide information with an answer hierarchy associated with the question in the question section 1602. The answer section 1604 may be divided into a main flow section 1616 and an alternative flow section 1618. The main flow section 1616 may dominate the space on the page and shows the choices as user moves down through each fork presented in an answer hierarchy. The main flow section 1616 may include a plurality of nodes from an answer hierarchy such as a Fork node 1620, a Step node 1622, and/or a Goto node 1624. Initially all nodes in the main flow section 1616 may be shown as the same size relative to one another; however, a node may expand and shrink as a user hovers over it (e.g., with a mouse) or moves away from it, respectively. Other methods such as different color schemes (e.g., highlight) may be used to emphasize the selection of nodes. In some embodiments, the nodes are numbered or otherwise ordered as in an outline to provide clarification on the position of the nodes relative to entire answer hierarchy. A Fork node 1620 is associated with a plurality of Branch nodes 1626 and 1628. Selecting any of the Branch nodes associated with a Fork node may expand all nodes associated with the selected branch node in the main flow section 1604. In some embodiments, a preview of the nodes associated with the alternative branch may be provided along with the selected node. Such a preview may be provided in response to a user action such as hovering over an alternative Branch node 1628. Alternatively, the preview may be provided without any user action.

The alternative flow section 1618 may include one or more icons or links each corresponding to an alternative Branch node that is not currently selected by a user. Selecting an alternative Branch node (e.g., by clicking on the corresponding icon or link) may cause the information of the selected branch to be displayed in the main flow section 1616 and the other branches displayed in the alternative flow section 1618. Thus, users may toggle between the display of alternative flows and the main flow. In some embodiments, different color schemes may be used to differentiate the main flow and alternative flows.

As discussed above, users may interact with a node in an answer hierarchy by providing node-specific information. For example, in the illustrated example, a user may contribute information to a given node by selecting from a plurality of types of information, each represented by a distinct icon 1630. For example, an icon with an R symbol may represent a reference, a paper clip icon may represent an attachment, a speech bubble may represent a comment and a question mark may represent a question. A numeric count may be displayed next to an icon of a type to show the number of files or objects of the given type. Selecting a given icon may enable a user to provide information of the selected type and/or view the information.

In addition to providing node-specific information, users may also provide general information that may be applicable to a subset of more than one node or to the entire answer hierarchy. In various embodiments, a user may be allowed to provide information associated with any suitable level of an answer hierarchy, from individual node level to the top level.

Users may also modify the structure of the answer hierarchy, for example, by adding nodes to it. In the illustrated example, each node may be associated with a “Participate” link or button 1632, the selection of which allows a user to add a node at the selected position. In other embodiments, a drag-and-drop interface may be provided to allow a user to drag nodes directly into an answer hierarchy.

The related information section 1606 may be configured to provide information or services related to the questions and answer. The related information section 1606 may include a related flows subsection 1634, an author bio subsection 1636, a participant's subsection 1640, a statistics subsection 1642, and a filters subsection 1644. The related flows subsection 1634 may provide links to questions and/or answers determined to be relevant to the current question. The author bio subsection 1636 may provide profile information of the author of a currently-selected aspect of the question or answer as well as his/her participation history 1638 (e.g., a list of recent questions or answers that the given author contributed to). Information contained in the author bio subsection 1636 may change dynamically as a user navigates down an answer hierarchy to reflect information pertaining to the currently selected node. In some embodiments, participation statistics of a given author may be provided (e.g., to management) as a means for measuring engagement and/or motivating participation. The participants subsection 1640 may provide the profile information of or links to a list of participates of the given answer hierarchy and/or related answers. The statistics subsection 1642 may include the total number of views, number of participants and/or other statistics related to the current question or answer. Finally, the filters subsection 1644 may enable a user to filter information and/or participation, for example, by the title of the contributors such as directors, associates, partners, etc.

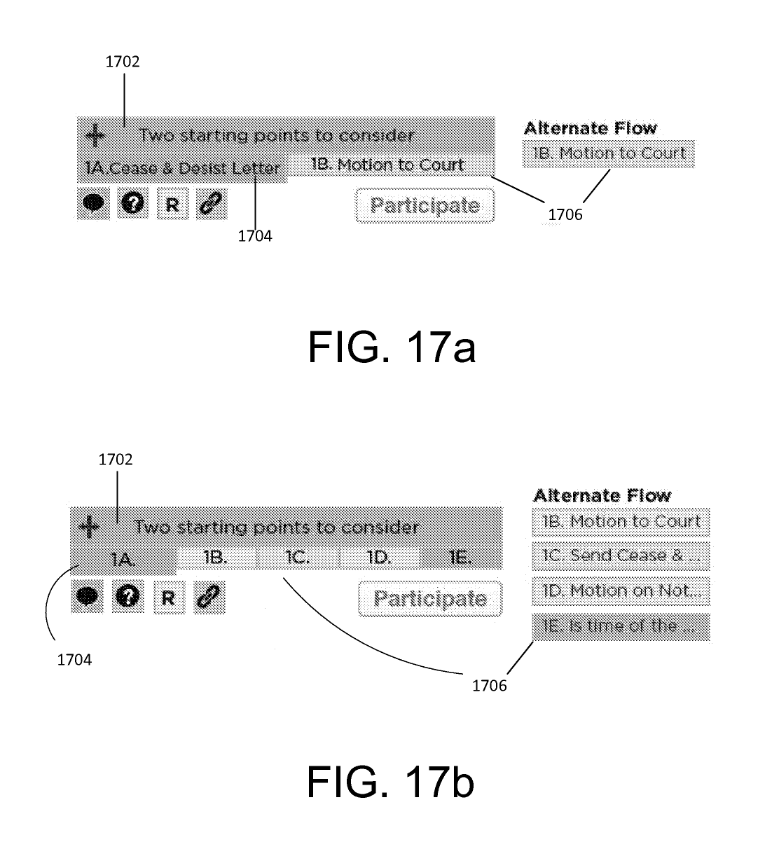

FIGS. 17a-b illustrate exemplary UIs representing forks in an answer hierarchy, in accordance with some embodiments. As illustrated, a fork in the answer hierarchy may include a Fork node 1702 and one or more tabs 1704 and 1706 representing Branch nodes associated with the Fork node 1702. A fork may be associated with two branches (such as illustrated by FIG. 17a) or more than two branches (such as illustrated by FIG. 17b). Selecting a branch tab 1702 causes details of the corresponding branch to be shown. Less detail is shown for the non-selected tabs 1704. For example, icons may be used to represent individual alternative branches in the alternative flows section. A user may toggle the display of the main and alternative branches by selecting the corresponding branch tabs. In some embodiments, different colors may be used to distinguish between the different branches, main or alternative branches and the like.

Representing fork branches as tabs in the UI can provide unique advantages. Compared with other representations (e.g., a spiderweb-like representation), the tab-representation makes more efficient use of the display area of the UI, making it cleaner and less cluttered. Furthermore, the tab-like representation unambiguously emphasizes the primary or dominant branch such as currently selected by a user, although preview of alternative (unselected branches) can also be provided alongside the primary branch.

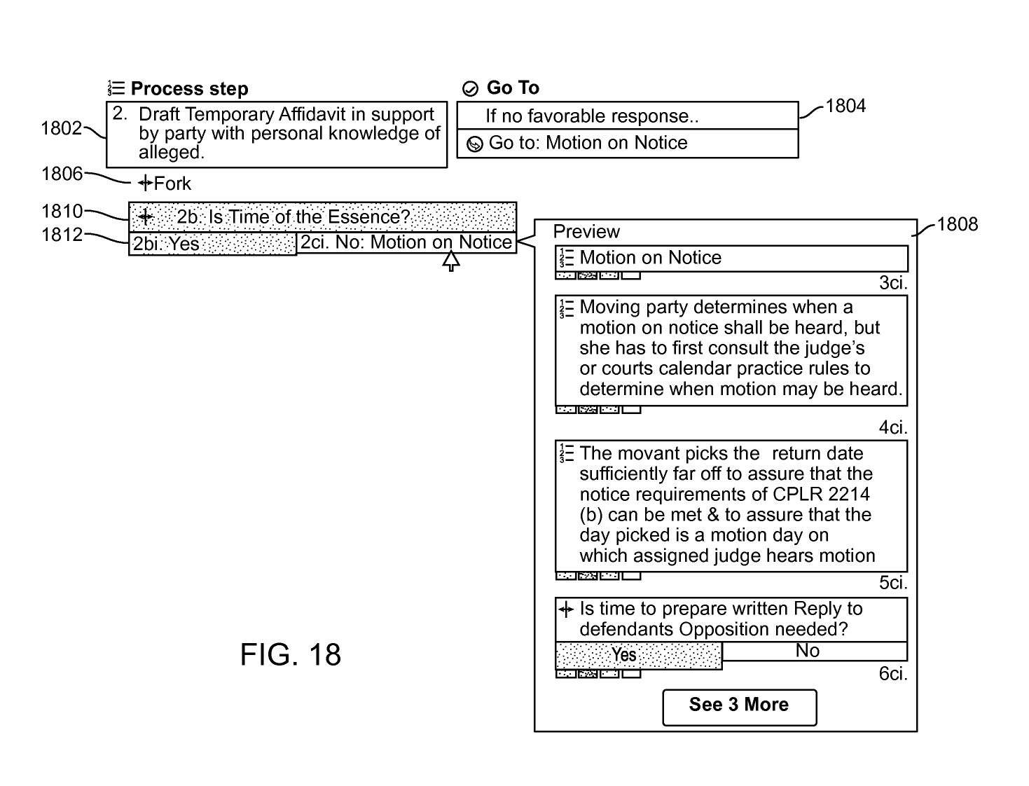

FIG. 18 illustrates exemplary UIs for some types of nodes in an answer hierarchy, in accordance with some embodiments. For example, a Step node 1802 may include a step number (e.g., “2”) and a description of the step (e.g., “Draft Temporary Affidavit in support by party with personal knowledge of alleged”). A Goto node 1804 may include a description of the source (e.g., “If no favorable response . . . ”) as well as a description and/or a link to the target of the Goto node (e.g., “Motion on Notice”). A Fork node 1806 may include a description 1810 as well as tabs 1812 corresponding to the associated Branch nodes. In some embodiments, a preview 1808 of an alternative branch may be displayed, for example, when a user places a mouse over the UI representation of the alternative branch (e.g., a tab). The preview may provide only high-level information pertaining to the alternative branch (e.g., with no ancillary information or author information). Advantageously, the preview provides a user with a side-by-side comparison of a main branch and an alternative branch in the same view without the user having to switch between views. In some embodiments, different types of nodes may be distinguished by different colors, shapes, textual representations or the like.

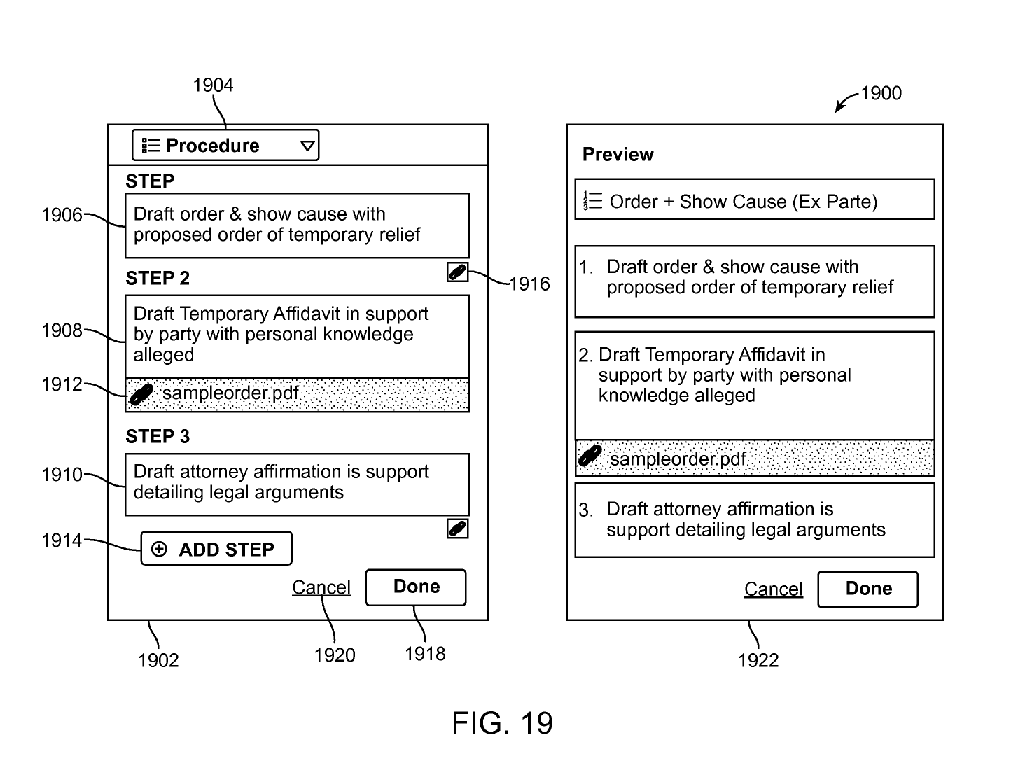

FIG. 19 illustrates an exemplary UI 1900 for creating one or more Step nodes, in accordance with some embodiments. In an embodiment, a Procedure input form 1902 may be provided for creating one or more Step nodes. Such an input form may be provided, for example, after a user selects a “Participation” link or a similar control such as illustrated in FIG. 16 and selects “Procedure” from a dropdown list 1904. Alternatively, the input form may be provided when a user drags and drops a “Procedure” component from a palette onto a graphical representation of the answer hierarchy (not shown). The user may navigate between different input types by selecting from the appropriate entry from the dropdown list 1904. The Procedure input form 1902 includes one or more text fields or boxes 1906, 1908 and 1910, each configured to receive description of a corresponding Step node. A user may add an additional step (and a new step input field or box) by selecting the “Add Step” button. A user may also remove existing steps (not shown). In some embodiments, a default number (e.g., three) of steps may be provided. A user may save entered information (e.g., by selecting the “Done” button 1918) or cancel the creation of the nodes (e.g., by selecting the “Cancel” link 1920).

In some embodiments, a user may add step-specific or node-specific information to a Step node. For example, a user may upload an attachment 1912 by selecting an attachment link 1916. The user may also have the ability to associate other types of information (not shown) with a step. In an embodiment, a preview 1922 of the created Step nodes may be provided to show what the UI would look like. Such a preview may be provided in real time as the user enters information or in response to a user's indication to preview the information.

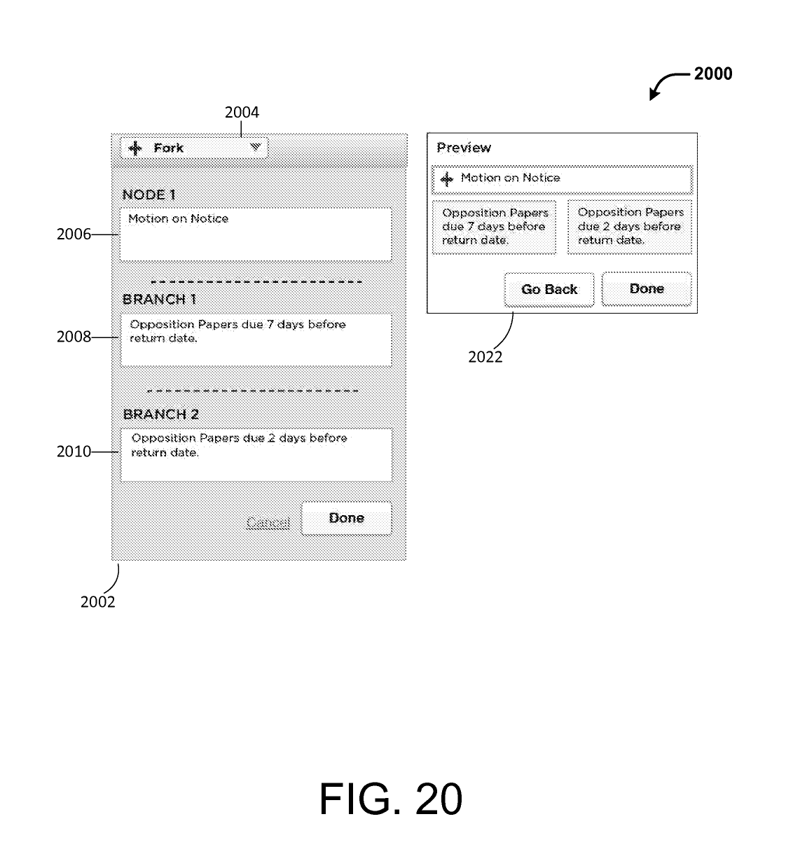

FIG. 20 illustrates an exemplary UI 2000 for creating Fork and Branch nodes, in accordance with some embodiments. In an embodiment, a Fork input form 2002 may be provided for creating a Fork node and associated Branch nodes (typically two or more). Such an input form may be provided, for example, after a user selects a “Participate” link or a similar control such as illustrated in FIG. 16 and selects “Fork” from a dropdown list 2004. Alternatively, the input form may be provided when a user drags and drops a “Fork” component from a palette onto a graphical representation of the answer hierarchy (not shown). The Fork input form 2002 includes a text field or box 2006 for a description of the Fork node, and two or more text fields or boxes 2008, 2010 for descriptions of two or more branches. In an embodiment, a user may add an additional branch, for example, by selecting an “Add Branch” button (not shown). A use may also remove existing branches using UI controls (not shown). In some embodiments, a default number (e.g., two) of branches may be provided.

In some embodiments, a user may add node-specific information associated with a Fork node or a Branch node in a manner similar to that described in connection with FIG. 19. In an embodiment, a preview 2022 of the created Fork and Branch nodes may be provided to show what the UI would look like. Such a preview may be provided in real time as the user enters information or in response to a user's indication to preview the information.

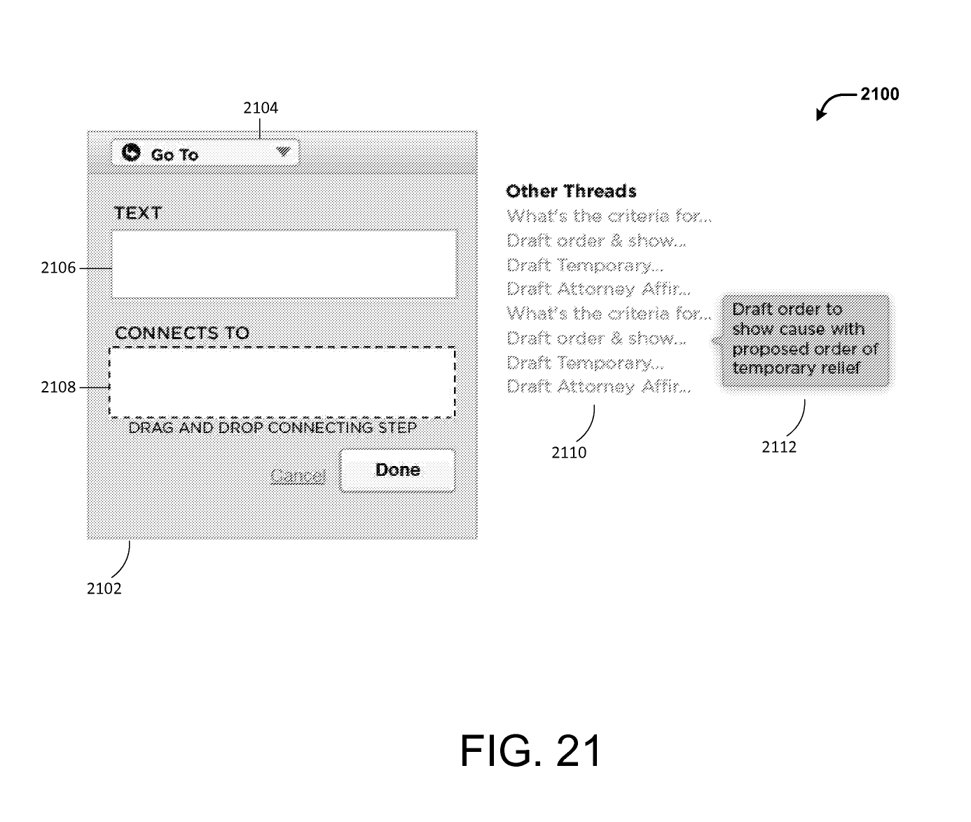

FIG. 21 illustrates an exemplary UI 2100 for creating a Goto node, in accordance with some embodiments. In an embodiment, a Goto input form 2102 may be provided for creating the Goto node. Such an input form may be provided, for example, after a user selects a “Participate” link or a similar control such as illustrated in FIG. 16 and selects “Go to” from a dropdown list 2104. Alternatively, the input form may be provided when a user drags and drops a “Goto” component from a palette onto a graphical representation of the answer hierarchy (not shown). The Goto input form 2102 includes a text field or box 2106 for a description of the Goto node, and a link field or box 2108 for providing a link to a target note. In an embodiment, a user may drag a node from a node list 2110 showing available nodes and drop it in the link box 2108. The node list 2110 may include all available nodes within the same answer hierarchy and/or in different answer hierarchies for the same or different (related or not) questions (such as illustrated by FIG. 6). The nodes displayed in the node list 2110 may be filtered according to system or user defined criteria such as access control or business rules. In an embodiment, hovering over a node in the node list 2110 causes the display of a complete description or preview 2112 of the node, for example, in a popup view. In some embodiments, a user may add node-specific information associated with a Fork node or a Branch node in a manner similar to that described in connection with FIG. 19.

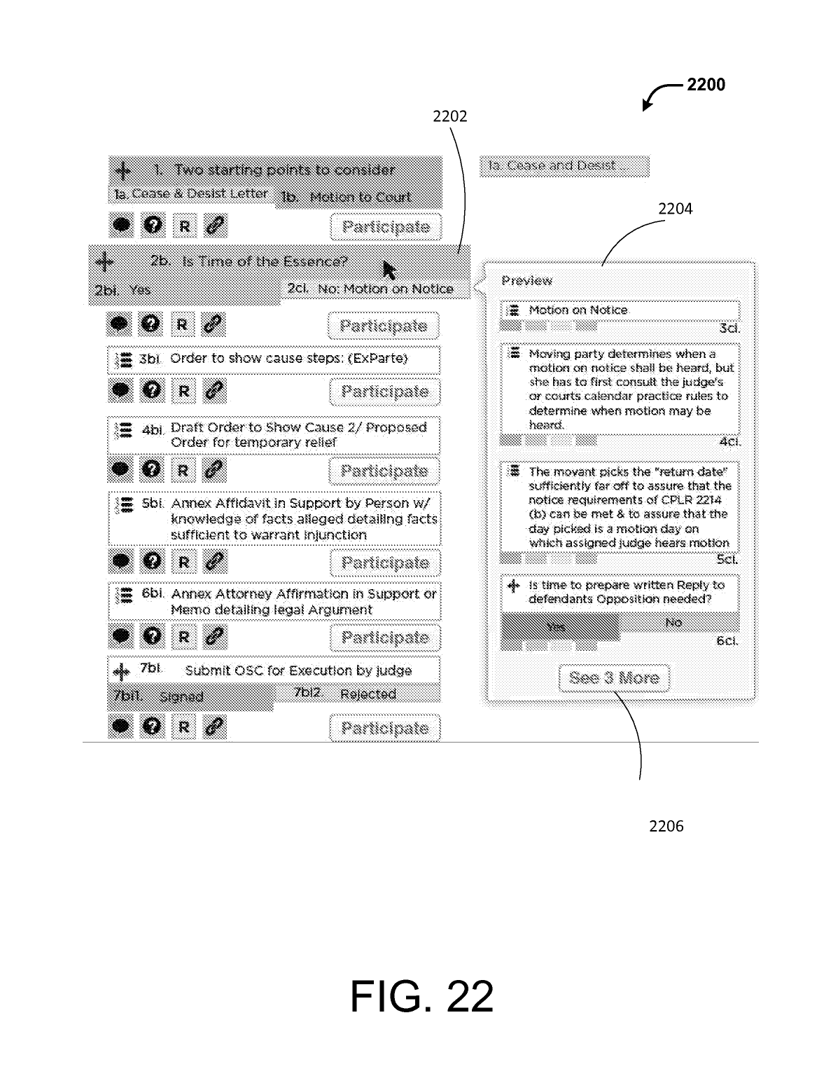

As discussed above, in some embodiments, the UI may highlight or otherwise emphasize an element in an answer hierarchy currently selected by a user. FIG. 22 illustrates an exemplary UI 2200 showing a selected element in an answer hierarchy, in accordance with some embodiments. In an embodiment, the UI 2200 may be displayed in an answer section similar to the answer section 1604 discussed in connection with FIG. 16. In the illustrated example, when a user selects (e.g., by clicking on or hovering over) an element, such as a Fork node 2202, the color and/or size of the element is changed to emphasize the selection and/or to provide further detail and legibility. In this example, the element is enlarged and the color is changed to distinguish from other nodes. Furthermore, a preview 2204 of an alternative flow or branch may be displayed, for example, beside the main flow or branch. In some embodiments, the preview 2204 may provide an abbreviated and/or high-level view of the information as opposed to a full and/or detailed view. In such cases, a “See more” 2206 or similar control may be provided to enable the user to see more information. Advantageously, the preview function allows a user to evaluate alternative branches or compare alternative branches with a currently selected branch without actually selecting the alternative branches.

In some embodiments, as a user scrolls down the main flow and makes choices, each node (e.g., branch) that the user traverses becomes part of the user's “Audit Trail” or “Action Plan.” A user may be presented the option to save, share, print or otherwise process or use such information, for example, when the end of the answer path is reached or at any other time.

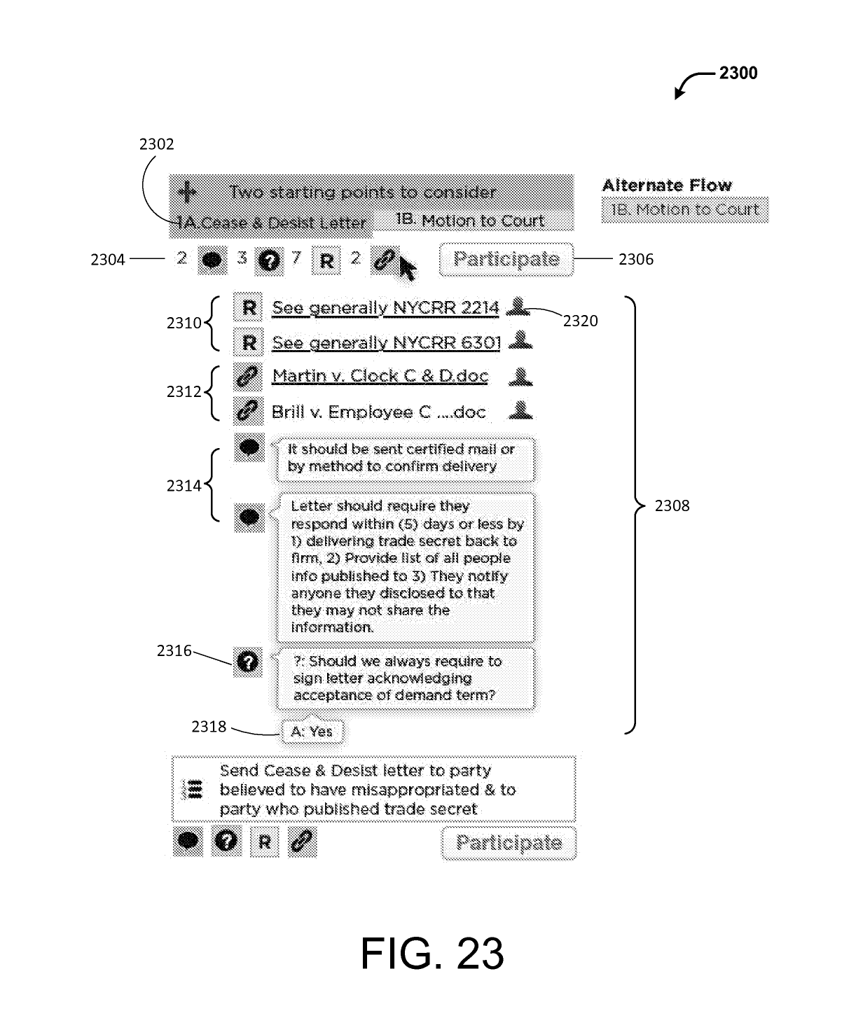

As discussed above, in some embodiments, users may add, remove, or otherwise modify information associated with a specific node in an answer hierarchy. FIG. 23 illustrates an exemplary UI 2300 showing a node 2302 with associated node-specific information 2308, in accordance with some embodiments. In some embodiments, a node may be shown in an expanded or collapsed view where some or all node-specific information may be shown or hidden. This example shows an expanded view of the Branch node 2302 (“1A. Cease & Desist Letter”) that provides node-specific information 2308. Such information 2308 may include references 2310, attachments 2312, comments 2314, questions 2316 (and answers thereof), and the like. The information 2308 may be provided by the same or different users 2320. Links to the users may be provided alongside the information provided by the users to facilitate interaction and accountability.

In an embodiment, one or more icons 2304 respectively representing various types of information (e.g., comments, questions, references, attachments) may be provided together with a numeric count. Selecting any of the icons 2304 may enable a user to add content or view previously provided content. In some embodiments, node-specific information may be added by selecting a “Participate” button 2306 or a similar control associated with a node. In some embodiments, such a button or control may be displayed only when a user selects or hovers over a node. Such an approach may help to conserve real estate of the screen and/or keep UI relatively clean and focused. In other embodiments, such a button or control is displayed whenever a node is displayed. In some embodiments, users may have the ability to select one or more pieces of node-specific information for saving, sharing, printing, or other purposes.

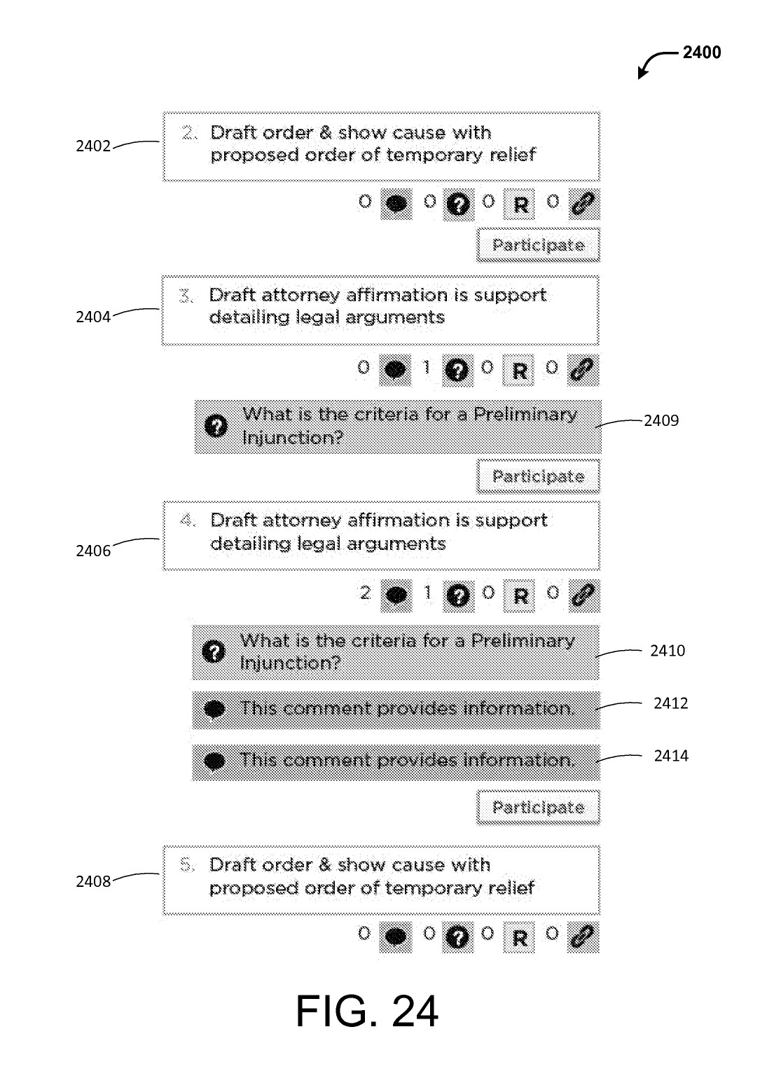

FIG. 24 illustrates a portion of an exemplary an answer hierarchy 2400, in accordance with some embodiments. The answer hierarchy 2400 includes a series of Step node 2402, 2404, 2406 and 2408. Node-specific information exists for some, but not all, of the nodes. For example, Step node 2404 has a question 2409 specific to the Step node 2404. As another example, Step node 2406 has a question 2410 and two comments 2412 and 2414. In some embodiments, node-specific information may be displayed in an expanded mode or a collapsed mode by default. The collapsed mode may serve to conserve screen real estate. For example, in some embodiments, all questions and comments may be displayed as collapsed by default. A user may select a given question or comment to toggle the display mode (e.g., from collapsed mode to expanded mode or vice versa). In some other embodiments, only certain types of nodes are displayed as expanded while the others may be displayed as collapsed. For example, in an embodiment, only questions are displayed as expanded whereas comments are displayed as collapsed. In such embodiments, a user may need to select a collapsed comment to see details of the comment. In yet other embodiments, both questions and comments are displayed as expanded by default. In some embodiments, hovering over a collapsed element may provide more detailed information of the element. In various embodiments, the display mode of various UI components may be provided according to system default, and/or configurable by administrators or users.

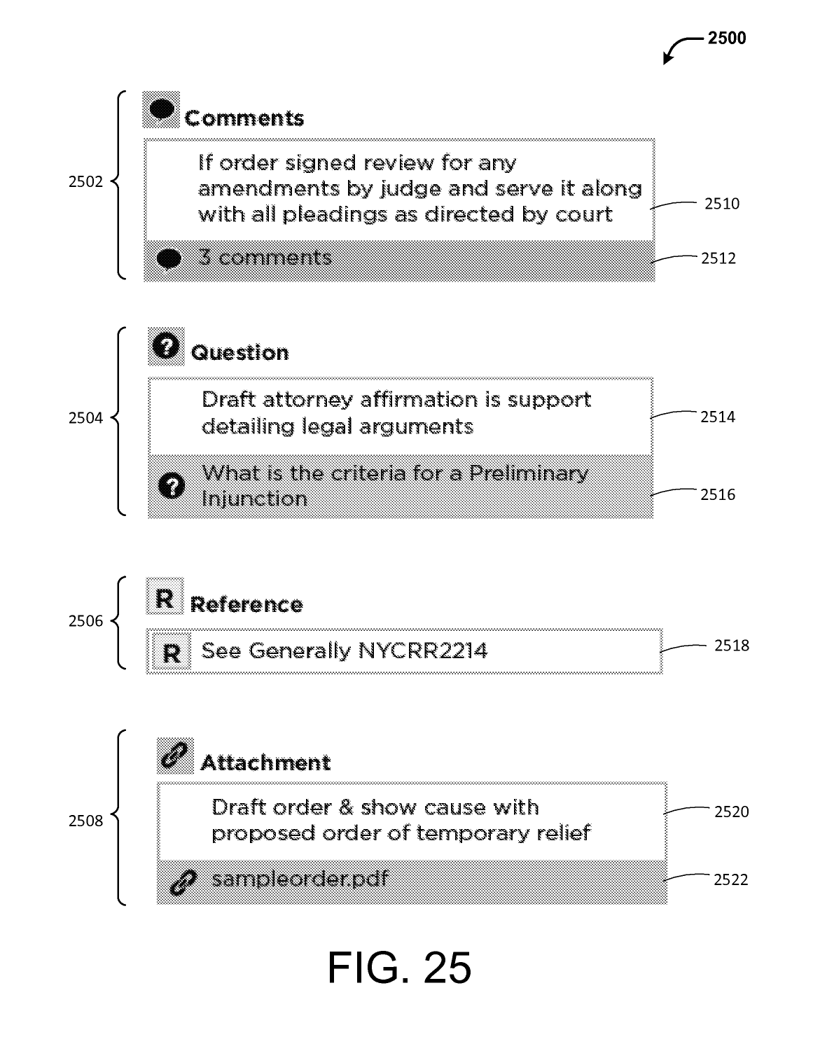

FIG. 25 illustrates exemplary UIs 2500 for displaying various types of node-specific information, in accordance with some embodiments. In this example, a comments section 2502 may include a description or title 2510 of node associated with the comments, as well as a list of comments 2512 which may be displayed as collapsed (as illustrated) or expanded. A question section 2504 may include a description or title 2514 of the node associated with the question, as well as the text 2516 of the question. A reference section 2506 may include a description 2518 of the reference that may also include a link to the reference. An attachment section 2508 may include a description or title 2520 of node associated with the question, as well as a link 2522 to the actual attachment.

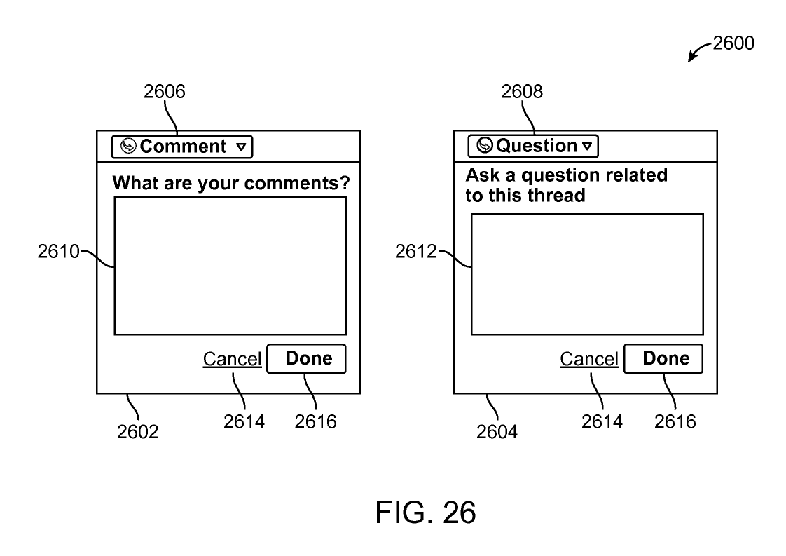

FIG. 26 illustrates exemplary UIs 2600 for creating comments and questions for a given node, in accordance with some embodiments. In an embodiment, a Comment input form 2602 and a Question input form 2604 may be provided for a user to provide one or more comments or questions, respectively, regarding a node. Such input forms may be provided, for example, after a user selects a “Participate” link or a similar control such as illustrated in FIG. 16 and selects “Comment” or “Question” from a dropdown list 2606 or 2608. In an embodiment, the input form may be provided when a user clicks on an icon representing a comment or question such as discussed in connection with FIG. 23. In an embodiment, the input forms may be provided when a user drags and drops a “Comment” or “Question” component at a given node. In an embodiment, the users may navigate between different information types by selecting from the appropriate entry from the dropdown list 2606 or 2608.

The Comment input form 2602 and Question input form 2604 may include a comment text box 2610 and a question text box 2612, respectively. A user may save entered information (e.g., by selecting the “Done” button 2616) or cancel the creation of node-specific information (e.g., by selecting the “Cancel” link 2614).

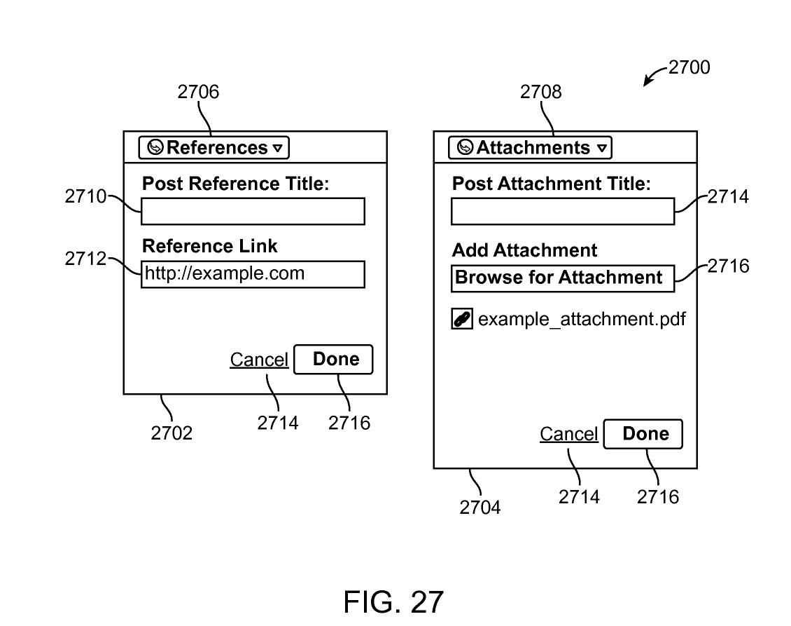

FIG. 27 illustrates exemplary UIs 2700 for creating references and attachments for a given node, in accordance with some embodiments. In an embodiment, a Reference input form 2702 and an Attachment input form 2704 may be provided for a user to provide one or more references or attachments, respectively, regarding a node. Such input forms may be provided, for example, after a user selects a “Participate” link or a similar control such as illustrated in FIG. 16 and selects “References” or “Attachments” from a dropdown list 2706 or 2708. In an embodiment, the input form may be provided when a user clicks on an icon representing a reference or attachment such as discussed in connection with FIG. 23. In another embodiment, the input forms may be provided when a user drags and drops a “Reference” or “Attachment” component at a given node. In an embodiment, the users may navigate between different information types by selecting from the appropriate entry from the dropdown list 2706 or 2708.

The Reference input form 2702 may include, for each reference, a text field 2710 for a description of the reference and a text field 2712 for a link (e.g., a URL) of the reference. A user may create more than one reference by selecting an “Add Reference” button (not shown) or a similar control.

The Attachment input form 2704 may include, for each attachment, a text field 2714 for a description of the attachment and a control 2716 for uploading the attachment. In some embodiments, the control 2716 may include a button or link that allows a user to browse and select file(s) from a local file system. In some other embodiments, the control 2716 may support a drag-and-drop interface. In various embodiments, a user may upload attachments one by one or multiple attachments at once.

A user may save entered information (e.g., by selecting the “Done” button 2716) or cancel the creation of node-specific information (e.g., by selecting the “Cancel” link 2714).

In various embodiments, the present invention may be used to manage knowledge in a wide range of industries or sectors. The industries may include legal industry, aerospace and defense, government agencies (e.g., federal, state and local), life sciences, power and utilities, retail and distribution, travel and hospitality, automotive, health care, media and entertainment, private equity and finance, transportation, banking and securities, health plans, military, process and industrial, high-technology, education, insurance, oil and gas, real estate, telecommunications and the like.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A computer-implemented method for managing knowledge, said method under the control of one or more computer systems configured with executable instructions and comprising:
receiving, via a user interface, a question from a first user; and
providing, via the user interface, an answer hierarchy corresponding to the question, the answer hierarchy generated at least in part on responses from one or more other users different from the first user and comprising a plurality of nodes each associated with a predefined node type.

2. The computer-implemented method of claim 1, wherein the answer hierarchy represents an aggregate answer to the question.

3. The computer-implemented method of claim 2, wherein each node in the answer hierarchy represents a step in a solution to the question.

4. The computer-implemented method of claim 1, wherein the predefined node type is selected from a group comprising a Step, Fork, or Goto node type.

5. The computer-implemented method of claim 2, wherein the plurality of nodes includes at least a Fork node with two or more branches.

6. The computer-implemented method of claim 5, wherein the Fork node represents a decision point among two or more solutions corresponding to the two or more branches.

7. The computer-implemented method of claim 1, wherein at least one of the plurality of nodes is associated with node-specific information.

8. The computer-implemented method of claim 7, wherein the node-specific information includes at least one of a comment, a question, a reference, or an attachment.

9. The computer-implemented method of claim 1, wherein providing the answer hierarchy includes allowing the one or more users to add, remove, or edit at least one node of the plurality of nodes.

10. The computer-implemented method of claim 9, wherein editing the at least one node includes adding, removing, or editing node-specific information associated with the at least one node.

11. The computer-implemented method of claim 1, wherein the answer hierarchy provides at least two distinct solutions to the question.

12. The computer-implemented method of claim 11, further comprising allowing the first user to select, via the user interface, a user-specific solution from the at least two distinct solutions based at least in part on information specific to the first user.

13. The computer-implemented method of claim 12, wherein selecting the user-specific solution includes selecting, via the user interface, a subset of the plurality of nodes of the answer hierarchy.

14. The computer-implemented method of claim 12, wherein the user-specific solution is displayed via the user interface.

15. The computer-implemented method of claim 13, further comprises displaying a first selected node of the plurality of nodes while providing a preview of a second unselected node of the plurality of nodes.

16. The computer-implemented method of claim 12, wherein the user-specific solution is stored, shared, or printed.

17. The computer-implemented method of claim 1, wherein the first user and the one or more other users different from the first user are members of the same organization or group.

18. The computer-implemented method of claim 1, wherein at least one of the one or more computer systems is configured to prevent unauthorized access.

19. The computer-implemented method of claim 18, wherein preventing unauthorized access comprises authenticating users of the one or more computer systems prior to providing access to the at least one of the one or more computer systems.

20. The computer-implemented method of claim 19, wherein authenticating the users of the one or more computer systems includes checking user-provided credentials.

21. The computer-implemented method of claim 19, wherein authenticating the users of the one or more computer systems is performed without user intervention.

22. The computer-implemented method of claim 1, wherein at least one of the one or more computer systems is configured to be non-public.

23. The computer-implemented method of claim 1, further comprising providing different levels of access rights with respect to the answer hierarchy to users of the one or more computer systems.

24. The computer-implemented method of claim 23, wherein providing different levels of access rights with respect to the answer hierarchy includes providing only read access to a first subset of the users and providing both read and write access to a second subset of the users.

25. The computer-implemented method of claim 24, wherein the first user is a member of the first subset of the users and at least one of the one or more users different from the first users is a member of the second subset of the users.

26. A knowledge management system, comprising:
one or more processors; and
memory, including instructions executable by the one or more processors to cause the knowledge management system to at least:
receive, via a user interface, a question from a first user; and
provide, via the user interface, an answer hierarchy corresponding to the question, the answer hierarchy generated at least in part on responses from one or more other users different from the first user and comprising a plurality of nodes each associated with a predefined node type.

27. The knowledge management system of claim 26, wherein the answer hierarchy represents an aggregate answer to the question.

28. The knowledge management system of claim 27, wherein each node in the answer hierarchy represents a step in a solution to the question.

29. The knowledge management system of claim 26, wherein the predefined node type is selected from a group comprising a Step, Fork, or Goto node type.

30. The knowledge management system of claim 27, wherein the plurality of nodes includes at least a Fork node with two or more branches.

31. The knowledge management system of claim 30, wherein the Fork node represents a decision point among two or more solutions corresponding to the two or more branches.

32. The knowledge management system of claim 26, wherein at least one of the plurality of nodes is associated with node-specific information.

33. The knowledge management system of claim 32, wherein the node-specific information includes at least one of a comment, a question, a reference, or an attachment.

34. The knowledge management system of claim 26, wherein providing the answer hierarchy includes allowing the one or more users to add, remove, or edit at least one node of the plurality of nodes.

35. The knowledge management system of claim 34, wherein editing the at least one node includes adding, removing, or editing node-specific information associated with the at least one node.

36. The knowledge management system of claim 26, wherein the answer hierarchy provides at least two distinct solutions to the question.

37. The knowledge management system of claim 36, wherein the instructions executable by the one or more processors further cause the knowledge management system to allow the first user to select, via the user interface, a user-specific solution from the at least two distinct solutions based at least in part on information specific to the first user.

38. The knowledge management system of claim 37, wherein selecting the user-specific solution includes selecting, via the user interface, a subset of the plurality of nodes of the answer hierarchy.

39. The knowledge management system of claim 37, wherein the user-specific solution is displayed via the user interface.

40. The knowledge management system of claim 38, wherein the instructions executable by the one or more processors further cause the knowledge management system to display a first selected node of the plurality of nodes while providing a preview of a second unselected node of the plurality of nodes.

41. The knowledge management system of claim 37, wherein the user-specific solution is stored, shared, or printed.

42. The knowledge management system of claim 26, wherein the first user and the one or more other users different from the first user are members of the same organization or group.

43. The knowledge management system of claim 26, wherein the instructions executable by the one or more processors further cause the knowledge management system to prevent unauthorized access.

44. The knowledge management system of claim 43, wherein preventing unauthorized access comprises authenticating users of the knowledge management system prior to providing access to the knowledge management system.

45. The knowledge management system of claim 44, wherein authenticating the users of the knowledge management system includes checking user-provided credentials.

46. The knowledge management system of claim 44, wherein authenticating the users of the knowledge management system is performed without user intervention.

47. The knowledge management system of claim 26, wherein the knowledge management system is configured to be non-public.

48. The knowledge management system of claim 26, wherein the instructions executable by the one or more processors further cause the knowledge management system to provide different levels of access rights with respect to the answer hierarchy to users of the knowledge management system.

49. The knowledge management system of claim 48, wherein providing different levels of access rights with respect to the answer hierarchy includes providing only read access to a first subset of the users and providing both read and write access to a second subset of the users.

50. The knowledge management system of claim 49, wherein the first user is a member of the first subset of the users and at least one of the one or more users different from the first users is a member of the second subset of the users.

51. One or more non-transitory computer-readable storage media having collectively stored thereon executable instructions that, when executed by one or more processors of a knowledge management system, cause the system to at least:
receive, via a user interface, a question from a first user; and
provide, via the user interface, an answer hierarchy corresponding to the question, the answer hierarchy generated at least in part on responses from one or more other users different from the first user and comprising a plurality of nodes each associated with a predefined node type.

52. The one or more non-transitory computer-readable storage media of claim 51, wherein the answer hierarchy represents an aggregate answer to the question.

53. The one or more non-transitory computer-readable storage media of claim 52, wherein each node in the answer hierarchy represents a step in a solution to the question.

54. The one or more non-transitory computer-readable storage media of claim 51, wherein the predefined node type is selected from a group comprising a Step, Fork, or Goto node type.

55. The one or more non-transitory computer-readable storage media of claim 52, wherein the plurality of nodes includes at least a Fork node with two or more branches.

56. The one or more non-transitory computer-readable storage media of claim 55, wherein the Fork node represents a decision point among two or more solutions corresponding to the two or more branches.

57. The one or more non-transitory computer-readable storage media of claim 51, wherein at least one of the plurality of nodes is associated with node-specific information.

58. The one or more non-transitory computer-readable storage media of claim 57, wherein the node-specific information includes at least one of a comment, a question, a reference, or an attachment.

59. The one or more non-transitory computer-readable storage media of claim 51, wherein providing the answer hierarchy includes allowing the one or more users to add, remove, or edit at least one node of the plurality of nodes.

60. The one or more non-transitory computer-readable storage media of claim 59, wherein editing the at least one node includes adding, removing, or editing node-specific information associated with the at least one node.

61. The one or more non-transitory computer-readable storage media of claim 51, wherein the answer hierarchy provides at least two distinct solutions to the question.

62. The one or more non-transitory computer-readable storage media of claim 61, wherein the instructions executable by the one or more processors further cause the knowledge management system to allow the first user to select, via the user interface, a user-specific solution from the at least two distinct solutions based at least in part on information specific to the first user.

63. The one or more non-transitory computer-readable storage media of claim 62, wherein selecting the user-specific solution includes selecting, via the user interface, a subset of the plurality of nodes of the answer hierarchy.

64. The one or more non-transitory computer-readable storage media of claim 62, wherein the user-specific solution is displayed via the user interface.

65. The one or more non-transitory computer-readable storage media of claim 63, wherein the instructions executable by the one or more processors further cause the knowledge management system to display a first selected node of the plurality of nodes while providing a preview of a second unselected node of the plurality of nodes.

66. The one or more non-transitory computer-readable storage media of claim 62, wherein the user-specific solution is stored, shared, or printed.

67. The one or more non-transitory computer-readable storage media of claim 51, wherein the first user and the one or more other users different from the first user are members of the same organization or group.

68. The one or more non-transitory computer-readable storage media of claim 51, wherein the instructions executable by the one or more processors further cause the knowledge management system to prevent unauthorized access.

69. The one or more non-transitory computer-readable storage media of claim 68, wherein preventing unauthorized access comprises authenticating users of the knowledge management system prior to providing access to the knowledge management system.

70. The one or more non-transitory computer-readable storage media of claim 69, wherein authenticating the users of the knowledge management system includes checking user-provided credentials.

71. The one or more non-transitory computer-readable storage media of claim 69, wherein authenticating the users of the knowledge management system is performed without user intervention.

72. The one or more non-transitory computer-readable storage media of claim 51, wherein the knowledge management system is configured to be non-public.

73. The one or more non-transitory computer-readable storage media of claim 51, wherein the instructions executable by the one or more processors further cause the knowledge management system to provide different levels of access rights with respect to the answer hierarchy to users of the knowledge management system.

74. The one or more non-transitory computer-readable storage media of claim 73, wherein providing different levels of access rights with respect to the answer hierarchy includes providing only read access to a first subset of the users and providing both read and write access to a second subset of the users.

75. The one or more non-transitory computer-readable storage media of claim 74, wherein the first user is a member of the first subset of the users and at least one of the one or more users different from the first users is a member of the second subset of the users.

76. A computer-implemented method for managing knowledge, said method under the control of one or more computer systems configured with executable instructions and comprising:
providing a user interface that enables a plurality of users to collectively edit an answer hierarchy that incorporates responses of the plurality of users to a user-provided question, the answer hierarchy comprising a plurality of nodes each associated with a predefined node type;
receiving, via the user interface, a user-selection of a subset of the plurality of nodes; and
providing a solution to the user-provided question based at least in part on the user-selected subset of the plurality of nodes.

77. The computer-implemented method of claim of claim 76, wherein the answer hierarchy represents an aggregate answer to the question.

78. The computer-implemented method of claim of claim 77, wherein each node in the answer hierarchy represents a step in a solution to the question.

79. The computer-implemented method of claim 76, wherein the predefined node type is selected from a group comprising a Step, Fork, or Goto node type.

80. The computer-implemented method of claim 76, wherein the plurality of nodes includes at least a Fork node with two or more branches.

81. The computer-implemented method of claim 80, wherein the Fork node represents a decision point among two or more solutions corresponding to the two or more branches.

82. The computer-implemented method of claim 76, wherein at least one of the plurality of nodes is associated with node-specific information.

83. The computer-implemented method of claim 82, wherein the node-specific information includes at least one of a comment, a question, a reference, or an attachment.

84. The computer-implemented method of claim 76, wherein editing the answer hierarchy includes adding, remove, or editing at least one node of the plurality of nodes.

85. The computer-implemented method of claim 84, wherein editing the at least one node includes adding, removing, or editing node-specific information associated with the at least one node.

86. The computer-implemented method of claim 76, wherein providing the solution to the question comprising displaying, via the user interface, the user-selected subset of the plurality of nodes.

87. The computer-implemented method of claim 86, wherein providing the solution to the question further comprises storing, sharing, or printing the solution.

88. The computer-implemented method of claim 76, further comprising displaying a first selected node of the plurality of nodes while providing a preview of a second unselected node of the plurality of nodes.

89. The computer-implemented method of claim 76, further comprising preventing unauthorized access.

90. The computer-implemented method of claim 89, wherein preventing unauthorized access comprises authenticating the plurality of users prior to providing access.

91. The computer-implemented method of claim 90, wherein authenticating the plurality of users includes checking user-provided credentials.

92. The computer-implemented method of claim 90, wherein authenticating the plurality of users is performed without user intervention.

93. The computer-implemented method of claim 76, further comprising providing different levels of access rights with respect to the answer hierarchy to users.

94. The computer-implemented method of claim 93, wherein providing different levels of access rights with respect to the answer hierarchy includes providing only read access to a first of the users and providing both read and write access to a second subset of the users.

95. A knowledge management system, comprising:
one or more processors; and
memory, including instructions executable by the one or more processors to cause the knowledge management system to at least:
provide a user interface that enables a plurality of users to collectively edit an answer hierarchy that incorporates responses of the plurality of users to a user-provided question, the answer hierarchy comprising a plurality of nodes each associated with a predefined node type;
receive, via the user interface, a user-selection of a subset of the plurality of nodes; and
provide a solution to the user-provided question based at least in part on the user-selected subset of the plurality of nodes.

96. The knowledge management system of claim 95, wherein the answer hierarchy represents an aggregate answer to the question.

97. The knowledge management system of claim 96, wherein each node in the answer hierarchy represents a step in a solution to the question.

98. The knowledge management system of claim 95, wherein the predefined node type is selected from a group comprising a Step, Fork, or Goto node type.

99. The knowledge management system of claim 95, wherein the plurality of nodes includes at least a Fork node with two or more branches.

100. The knowledge management system of claim 99, wherein the Fork node represents a decision point among two or more solutions corresponding to the two or more branches.

101. The knowledge management system of claim 95, wherein at least one of the plurality of nodes is associated with node-specific information.

102. The knowledge management system of claim 101, wherein the node-specific information includes at least one of a comment, a question, a reference, or an attachment.

103. The knowledge management system of claim 95, wherein editing the answer hierarchy includes adding, remove, or editing at least one node of the plurality of nodes.

104. The knowledge management system of claim 103, wherein editing the at least one node includes adding, removing, or editing node-specific information associated with the at least one node.

105. The knowledge management system of claim 95, wherein providing the solution to the question comprising displaying, via the user interface, the user-selected subset of the plurality of nodes.

106. The knowledge management system of claim 105, wherein providing the solution to the question further comprises storing, sharing, or printing the solution.

107. The knowledge management system of claim 95, wherein the instructions executable by the one or more processors further cause the knowledge management system to display a first selected node of the plurality of nodes while providing a preview of a second unselected node of the plurality of nodes.

108. The knowledge management system of claim 95, wherein the instructions executable by the one or more processors further cause the knowledge management system to prevent unauthorized access.

109. The knowledge management system of claim 108, wherein preventing unauthorized access comprises authenticating the plurality of users prior to providing access.

110. The knowledge management system of claim 109, wherein authenticating the plurality of users includes checking user-provided credentials.

111. The knowledge management system of claim 109, wherein authenticating the plurality of users is performed without user intervention.

112. The knowledge management system of claim 95, wherein the instructions executable by the one or more processors further cause the knowledge management system to provide different levels of access rights with respect to the answer hierarchy to users of the knowledge management system.

113. The knowledge management system of claim 112, wherein providing different levels of access rights with respect to the answer hierarchy includes providing only read access to a first of the users and providing both read and write access to a second subset of the users.

114. One or more non-transitory computer-readable storage media having collectively stored thereon executable instructions that, when executed by one or more processors of a knowledge management system, cause the system to at least:
provide a user interface that enables a plurality of users to collectively edit an answer hierarchy that incorporates responses of the plurality of users to a user-provided question, the answer hierarchy comprising a plurality of nodes each associated with a predefined node type;
receive, via the user interface, a user-selection of a subset of the plurality of nodes; and
provide a solution to the user-provided question based at least in part on the user-selected subset of the plurality of nodes.

115. The one or more non-transitory computer-readable storage media of claim 114, wherein the answer hierarchy represents an aggregate answer to the question.

116. The one or more non-transitory computer-readable storage media of claim 115, wherein each node in the answer hierarchy represents a step in a solution to the question.

117. The one or more non-transitory computer-readable storage media of claim 114, wherein the predefined node type is selected from a group comprising a Step, Fork, or Goto node type.

118. The one or more non-transitory computer-readable storage media of claim 114, wherein the plurality of nodes includes at least a Fork node with two or more branches.

119. The one or more non-transitory computer-readable storage media of claim 118, wherein the Fork node represents a decision point among two or more solutions corresponding to the two or more branches.

120. The one or more non-transitory computer-readable storage media of claim 114, wherein at least one of the plurality of nodes is associated with node-specific information.

121. The one or more non-transitory computer-readable storage media of claim 120, wherein the node-specific information includes at least one of a comment, a question, a reference, or an attachment.

122. The one or more non-transitory computer-readable storage media of claim 114, wherein editing the answer hierarchy includes adding, remove, or editing at least one node of the plurality of nodes.

123. The one or more non-transitory computer-readable storage media of claim 122, wherein editing the at least one node includes adding, removing, or editing node-specific information associated with the at least one node.

124. The one or more non-transitory computer-readable storage media of claim 114, wherein providing the solution to the question comprising displaying, via the user interface, the user-selected subset of the plurality of nodes.

125. The one or more non-transitory computer-readable storage media of claim 124, wherein providing the solution to the question further comprises storing, sharing, or printing the solution.

126. The one or more non-transitory computer-readable storage media of claim 114, wherein the instructions executable by the one or more processors further cause the knowledge management system to display a first selected node of the plurality of nodes while providing a preview of a second unselected node of the plurality of nodes.

127. The one or more non-transitory computer-readable storage media of claim 114, wherein the instructions executable by the one or more processors further cause the knowledge management system to prevent unauthorized access.

128. The one or more non-transitory computer-readable storage media of claim 127, wherein preventing unauthorized access comprises authenticating the plurality of users prior to providing access.

129. The one or more non-transitory computer-readable storage media of claim 128, wherein authenticating the plurality of users includes checking user-provided credentials.

130. The one or more non-transitory computer-readable storage media of claim 128, wherein authenticating the plurality of users is performed without user intervention.

131. The one or more non-transitory computer-readable storage media of claim 114, wherein the instructions executable by the one or more processors further cause the knowledge management system to provide different levels of access rights with respect to the answer hierarchy to users of the knowledge management system.

132. The one or more non-transitory computer-readable storage media of claim 131, wherein providing different levels of access rights with respect to the answer hierarchy includes providing only read access to a first of the users and providing both read and write access to a second subset of the users.

133. A computer-implemented method for managing knowledge, said method under the control of one or more computer systems configured with executable instructions and comprising: receiving, via a user interface, a question from a first user; and
displaying, via a user interface, an answer hierarchy that incorporates one or more solutions to a user-provided question, the answer hierarchy comprising a plurality of nodes each associated with a predefined node type, each of the one or more solutions corresponding to a subset of the plurality of nodes; and
allowing one or more users to perform, via the user interface, one or more predefined operations associated with the answer hierarchy, the one or more predefined operations comprising at least adding, removing, or editing at least one node of the plurality of nodes.

134. The computer-implemented method of claim 133, wherein the answer hierarchy represents an aggregate answer to the question.

135. The computer-implemented method of claim 134, wherein each node in the answer hierarchy represents a step in a solution to the question.

136. The computer-implemented method of claim 133, wherein the predefined node type is selected from a group comprising a Step, Fork, or Goto node type.

137. The computer-implemented method of claim 134, wherein the plurality of nodes includes at least a Fork node with two or more branches.

138. The computer-implemented method of claim 137, wherein the Fork node represents a decision point among two or more solutions corresponding to the two or more branches.

139. The computer-implemented method of claim 133, wherein at least one of the plurality of nodes is associated with node-specific information.

140. The computer-implemented method of claim 139, wherein the node-specific information includes at least one of a comment, a question, a reference, or an attachment.

141. The computer-implemented method of claim 133, wherein editing the at least one node comprises adding, removing, or editing node-specific information associated with the at least one node.

142. The computer-implemented method of claim 133, further comprising:
receiving, via the user interface, a user-selection of a subset of the plurality of nodes; and
providing one of the one or more solutions to the user-provided question based at least in part on the user-selected subset of the plurality of nodes.

143. The computer-implemented method of claim 142, wherein providing one of the one or more solutions comprises displaying the solution via the user interface.

144. The computer-implemented method of claim 143, wherein providing one of the one or more solutions further comprises storing, sharing, or printing the solution.

145. The computer-implemented method of claim 133, further comprising displaying a first selected node of the plurality of nodes while providing a preview of a second unselected node of the plurality of nodes.

146. The computer-implemented method of claim 133, wherein at least one of the one or more computer systems is configured to prevent unauthorized access.

147. The computer-implemented method of claim 146, wherein preventing unauthorized access comprises authenticating users of the one or more computer systems prior to providing access to the at least one of the one or more computer systems.

148. The computer-implemented method of claim 147, wherein authenticating the users of the one or more computer systems includes checking user-provided credentials.

149. The computer-implemented method of claim 148, wherein authenticating the users of the one or more computer systems is performed without user intervention.

150. The computer-implemented method of claim 133, wherein at least one of the one or more computer systems is configured to be non-public.

151. The computer-implemented method of claim 133, further comprising providing different levels of access rights with respect to the answer hierarchy to users of the one or more computer systems.

152. The computer-implemented method of claim 151, wherein providing different levels of access rights with respect to the answer hierarchy includes providing only read access to a first subset of the users and providing both read and write access to a second subset of the users.

153. A knowledge management system, comprising:
one or more processors; and
memory, including instructions executable by the one or more processors to cause the knowledge management system to at least:
display, via a user interface, an answer hierarchy that incorporates one or more solutions to a user-provided question, the answer hierarchy comprising a plurality of nodes each associated with a predefined node type, each of the one or more solutions corresponding to a subset of the plurality of nodes; and
allow one or more users to perform, via the user interface, one or more predefined operations associated with the answer hierarchy, the one or more predefined operations comprising at least adding, removing, or editing at least one node of the plurality of nodes.

154. The knowledge management system of claim 153, wherein the answer hierarchy represents an aggregate answer to the question.

155. The knowledge management system of claim 154, wherein each node in the answer hierarchy represents a step in a solution to the question.

156. The knowledge management system of claim 154, wherein the predefined node type is selected from a group comprising a Step, Fork, or Goto node type.

157. The knowledge management system of claim 154, wherein the plurality of nodes includes at least a Fork node with two or more branches.

158. The knowledge management system of claim 157, wherein the Fork node represents a decision point among two or more solutions corresponding to the two or more branches.

159. The knowledge management system of claim 153, wherein at least one of the plurality of nodes is associated with node-specific information.

160. The knowledge management system of claim 159, wherein the node-specific information includes at least one of a comment, a question, a reference, or an attachment.

161. The knowledge management system of claim 153, wherein editing the at least one node comprises adding, removing, or editing node-specific information associated with the at least one node.

162. The knowledge management system of claim 153, wherein the instructions executable by the one or more processors further cause the knowledge management system to:
receive, via the user interface, a user-selection of a subset of the plurality of nodes; and
provide one of the one or more solutions to the user-provided question based at least in part on the user-selected subset of the plurality of nodes.

163. The knowledge management system of claim 162, wherein providing one of the one or more solutions comprises displaying the solution via the user interface.

164. The knowledge management system of claim 163, wherein providing one of the one or more solutions further comprises storing, sharing, or printing the solution.

165. The knowledge management system of claim 153, wherein the instructions executable by the one or more processors further cause the knowledge management system to display a first selected node of the plurality of nodes while providing a preview of a second unselected node of the plurality of nodes.

166. The knowledge management system of claim 153, wherein the knowledge management system is configured to prevent unauthorized access.

167. The knowledge management system of claim 166, wherein preventing unauthorized access comprises authenticating users of the knowledge management system prior to providing access to the at least one of the knowledge management system.

168. The knowledge management system of claim 167, wherein authenticating the users of the knowledge management system includes checking user-provided credentials.

169. The knowledge management system of claim 168, wherein authenticating the users of the knowledge management system is performed without user intervention.

170. The knowledge management system of claim 153, wherein the knowledge management system is configured to be non-public.

171. The knowledge management system of claim 153, wherein the instructions executable by the one or more processors further cause the knowledge management system to provide different levels of access rights with respect to the answer hierarchy to users of the knowledge management system.

172. The knowledge management system of claim 171, wherein providing different levels of access rights with respect to the answer hierarchy includes providing only read access to a first subset of the users and providing both read and write access to a second subset of the users.

173. One or more non-transitory computer-readable storage media having collectively stored thereon executable instructions that, when executed by one or more processors of a knowledge management system, cause the system to at least:
display, via a user interface, an answer hierarchy that incorporates one or more solutions to a user-provided question, the answer hierarchy comprising a plurality of nodes each associated with a predefined node type, each of the one or more solutions corresponding to a subset of the plurality of nodes; and
allow one or more users to perform, via the user interface, one or more predefined operations associated with the answer hierarchy, the one or more predefined operations comprising at least adding, removing, or editing at least one node of the plurality of nodes.

174. The one or more non-transitory computer-readable storage media of claim 173, wherein the answer hierarchy represents an aggregate answer to the question.

175. The one or more non-transitory computer-readable storage media of claim 174, wherein each node in the answer hierarchy represents a step in a solution to the question.

176. The one or more non-transitory computer-readable storage media of claim 174, wherein the predefined node type is selected from a group comprising a Step, Fork, or Goto node type.

177. The one or more non-transitory computer-readable storage media of claim 174, wherein the plurality of nodes includes at least a Fork node with two or more branches.

178. The one or more non-transitory computer-readable storage media of claim 177, wherein the Fork node represents a decision point among two or more solutions corresponding to the two or more branches.

179. The one or more non-transitory computer-readable storage media of claim 173, wherein at least one of the plurality of nodes is associated with node-specific information.

180. The one or more non-transitory computer-readable storage media of claim 179, wherein the node-specific information includes at least one of a comment, a question, a reference, or an attachment.

181. The one or more non-transitory computer-readable storage media of claim 173, wherein editing the at least one node comprises adding, removing, or editing node-specific information associated with the at least one node.

182. The one or more non-transitory computer-readable storage media of claim 173, wherein the instructions executable by the one or more processors further cause the knowledge management system to:
receive, via the user interface, a user-selection of a subset of the plurality of nodes; and
provide one of the one or more solutions to the user-provided question based at least in part on the user-selected subset of the plurality of nodes.

183. The one or more non-transitory computer-readable storage media of claim 182, wherein providing one of the one or more solutions comprises displaying the solution via the user interface.

184. The one or more non-transitory computer-readable storage media of claim 183, wherein providing one of the one or more solutions further comprises storing, sharing, or printing the solution.

185. The one or more non-transitory computer-readable storage media of claim 173, the instructions executable by the one or more processors further cause the knowledge management system to display a first selected node of the plurality of nodes while providing a preview of a second unselected node of the plurality of nodes.

186. The one or more non-transitory computer-readable storage media of claim 173, wherein the knowledge management system is configured to prevent unauthorized access.

187. The one or more non-transitory computer-readable storage media of claim 186, wherein preventing unauthorized access comprises authenticating users of the knowledge management system prior to providing access to the at least one of the knowledge management system.

188. The one or more non-transitory computer-readable storage media of claim 187, wherein authenticating the users of the knowledge management system includes checking user-provided credentials.

189. The one or more non-transitory computer-readable storage media of claim 188, wherein authenticating the users of the knowledge management system is performed without user intervention.

190. The one or more non-transitory computer-readable storage media of claim 173, wherein the knowledge management system is configured to be non-public.

191. The one or more non-transitory computer-readable storage media of claim 173, wherein the instructions executable by the one or more processors further cause the knowledge management system to provide different levels of access rights with respect to the answer hierarchy to users of the knowledge management system.

192. The one or more non-transitory computer-readable storage media of claim 191, wherein providing different levels of access rights with respect to the answer hierarchy includes providing only read access to a first subset of the users and providing both read and write access to a second subset of the users.
